(19) United States
(12) Patent Application Publication
(10) Pub. No.: US 2012/0154692 A1
(43) Pub. Date: Jun. 21, 2012

(54) LIGHTING DEVICE, DISPLAY DEVICE AND TELEVISION RECEIVER

(75) Inventors: Yasumori Kuromizu, Osaka-shi (JP); Kenichi Iwamoto, Osaka-shi (JP); Kiyoshi Kakuda, Osaka-shi (JP); Mayumi Nakamura, Osaka-shi (JP)

(73) Assignee: SHARP KABUSHIKI KAISHA, Osaka-shi, Osaka (JP)

(21) Appl. No.: 13/393,593

(22) PCT Filed: Jul. 12, 2010
(86) PCT No.: PCT/JP2010/061758

§ 371 Date: Mar. 1, 2012

(30) Foreign Application Priority Data
Sep. 15, 2009 (JP) 2009-213438

(51) Int. Cl. H04N 5/66; F21V 29/02; G02F 1/13357; G09F 13/04

(52) U.S. Cl. 348/739; 362/97.1; 349/61; 348/E05.133

(57) ABSTRACT

A lighting device includes a hot cathode tube (17) and a chassis (14) housing the hot cathode tube (17). The discharge tube includes an exposed portion that is exposed to the outside of the chassis (14). The lighting device further includes an inverter board (26) configured to supply driving power to the hot cathode tube (17). The hot cathode tube (17) has an a glass tube (17a) and a ferrule (17b) which is electrically connected to the inverter board (26), and the exposed portion of the hot cathode tube (17) is the ferrule (17B).

### TECHNICAL FIELD

The present invention relates to a lighting device, a display device and a television receiver.

### BACKGROUND ART

A liquid crystal panel used for, for example, a liquid crystal display device such as a liquid crystal television does not emit light, and therefore requires a backlight unit separately as a lighting device. This backlight unit is configured to be installed on the back side (the side opposite to the side having the display surface) of the liquid crystal panel. The backlight unit includes a chassis, a face of which toward the liquid crystal panel is open; and a light source housed in the chassis (Patent Document 1 mentioned below). For example, a discharge tube such as a cathode-ray tube is used as a light source of a backlight unit configured as described above.

Patent Document 1: Japanese Unexamined Patent Publication No. 2006-114445

### Problem to be Solved by the Invention

Incidentally, the brightness of a discharge tube in general changes as the ambient temperature changes. This is because, as the ambient temperature changes, the temperature of a spot (the coldest spot) that has the lowest temperature inside the tube changes, resulting in a change in vapor pressure of mercury enclosed in the tube, which further changes luminous efficiency. Specifically, while the brightness is the highest when the temperature of the coldest spot is at a particular temperature (an appropriate temperature), the brightness decreases when the temperature of the coldest spot becomes either above or below the appropriate temperature. When a discharge tube is housed in a chassis in the same manner as in the configuration used in Patent Document 1, the heat dissipation performance thereof is impaired, whereby the ambient temperature rises when the discharge tube is switched on. When the coldest spot is brought above the appropriate temperature as a result, there is a risk that the brightness decreases.

### DISCLOSURE OF THE PRESENT INVENTION

The present invention was made in view of the foregoing circumstances, and aims at providing a lighting device enabled to prevent the brightness thereof from decreasing due to temperature, and a display device and a television receiver which use the lighting device.

### Means for Solving the Problem

In order to solve the above problem, a lighting device according to the present invention includes a discharge tube, and a chassis housing the discharge tube. The discharge tube includes an exposed portion that is exposed to the outside of the chassis.

According to the present invention, the partial exposure of the discharge tube to the outside of the chassis facilitates heat dissipation from an exposed portion thereof, whereby the spot (coldest spot), inside the discharge tube, that has the lowest temperature comes to exist in the exposed portion. Therefore, the temperature of the coldest spot when the discharge tube is illuminated can be lowered as compared to a configuration having the whole discharge tube housed in the chassis, the inside of which tends to be filled with heat. This makes it possible to prevent the brightness from decreasing due to heating up of the coldest spot.

### BRIEF DESCRIPTION OF THE DRAWINGS

FIG. 1 is an exploded perspective view showing a schematic configuration of a television receiver according to Embodiment 1 of the present invention.

FIG. 2 is an exploded perspective view showing a schematic configuration of a liquid crystal display device included in the television receiver of FIG. 1.

FIG. 3 is a cross-sectional view showing a sectional configuration of the liquid crystal display device of FIG. 2, taken along a direction parallel to the short sides thereof.

FIG. 4 is a cross-sectional view showing a sectional configuration of the liquid crystal display device of FIG. 2, taken along a direction parallel to the long sides thereof.

FIG. 5 is an enlarged view showing an aspect in which an elastic member has been attached to a hot cathode tube.

FIG. 6 is a schematic view showing an aspect in which the hot cathode tube is being attached to a chassis in Embodiment 1.

FIG. 7 is a schematic view showing an aspect in which the hot cathode tube has been attached to the chassis in Embodiment 1.

FIG. 8 is a graph showing relations between the brightness of the hot cathode tube and the ambient temperature.

FIG. 9 is a schematic view showing an aspect in which a hot cathode tube is being attached to a chassis in Embodiment 2.

FIG. 10 is a cross-sectional schematic view showing the configuration of a liquid crystal display device according to Embodiment 3.

FIG. 11 is a schematic view showing the configuration of a backlight unit according to Embodiment 4.

FIG. 12 is a schematic view showing the configuration of a backlight unit according to Embodiment 5.

FIG. 13 is a schematic view showing the configuration of a backlight unit according to Embodiment 6.

FIG. 14 is a schematic view showing the configuration of a backlight unit according to Embodiment 7.

FIG. 15 is a schematic view showing the configuration of a backlight unit according to Embodiment 8.

FIG. 16 is a schematic view showing the configuration of a backlight unit according to Embodiment 9.

FIG. 17 is a schematic view showing the configuration of a backlight unit according to Embodiment 10.

FIG. 18 is a schematic view showing the configuration of a backlight unit according to Embodiment 11.

FIG. 19 is a schematic view showing the configuration of a backlight unit according to Embodiment 12.

FIG. 20 is a schematic view showing the configuration of a backlight unit according to Embodiment 13.

FIG. 21 is a schematic view showing the configuration of a backlight unit according to Embodiment 14.

FIG. 22 is a schematic view showing the configuration of a backlight unit according to Embodiment 15.

FIG. 23 is a schematic view showing the configuration of a liquid crystal display device according to Embodiment 16.

FIG. 24 is a schematic view showing the configuration of a liquid crystal display device according to Embodiment 17.

FIG. 25 is a schematic view showing the configuration of a liquid crystal display device according to Embodiment 18.

FIG. 26 is a schematic view showing the configuration of a liquid crystal display device according to Embodiment 19.

FIG. 27 is a schematic view showing the configuration of a liquid crystal display device according to Embodiment 20.

FIG. 28 is a cross-sectional view showing an aspect in which only one ferrule of a hot cathode tube at one end thereof is exposed to the outside of the chassis.

FIG. 29 is a cross-sectional view showing an aspect in which a glass tube of a hot cathode tube is L-shaped.

FIG. 30 is a schematic view showing an aspect in which a glass tube of a hot cathode tube has a shape of a katakana “ko”.

FIG. 31 is a schematic view showing an aspect in which a glass tube of a hot cathode tube is sigmoid.

FIG. 32 is a schematic view showing the configuration of a backlight unit according to Embodiment 21.

FIG. 33 is a schematic view showing the configuration of a backlight unit according to Embodiment 22.

FIG. 34 is a schematic view showing the configuration of a backlight unit according to Embodiment 23.

FIG. 35 is a schematic view showing the configuration of a backlight unit according to Embodiment 24.

FIG. 36 is a schematic view showing the configuration of a backlight unit according to Embodiment 25.

FIG. 37 is a schematic view showing the configuration of a backlight unit according to Embodiment 26.

FIG. 38 is a schematic view showing the configuration of a liquid crystal display device according to Embodiment 27.

FIG. 39 is a schematic view showing the configuration of a liquid crystal display device according to Embodiment 28.

### BEST MODE FOR CARRYING OUT THE INVENTION

### Embodiment 1

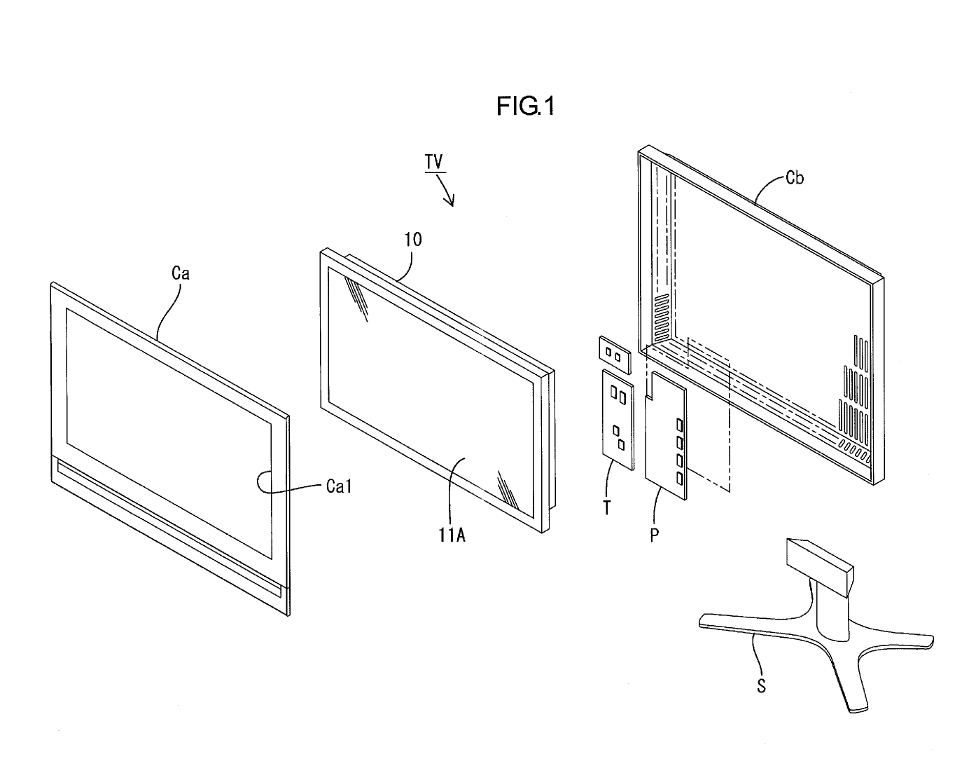

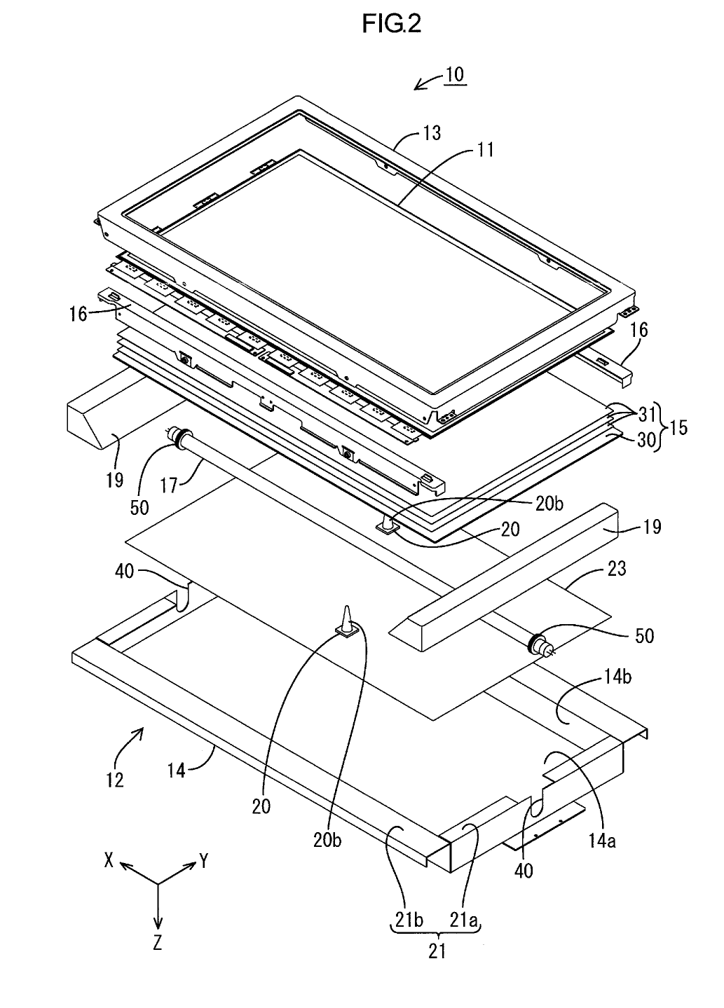

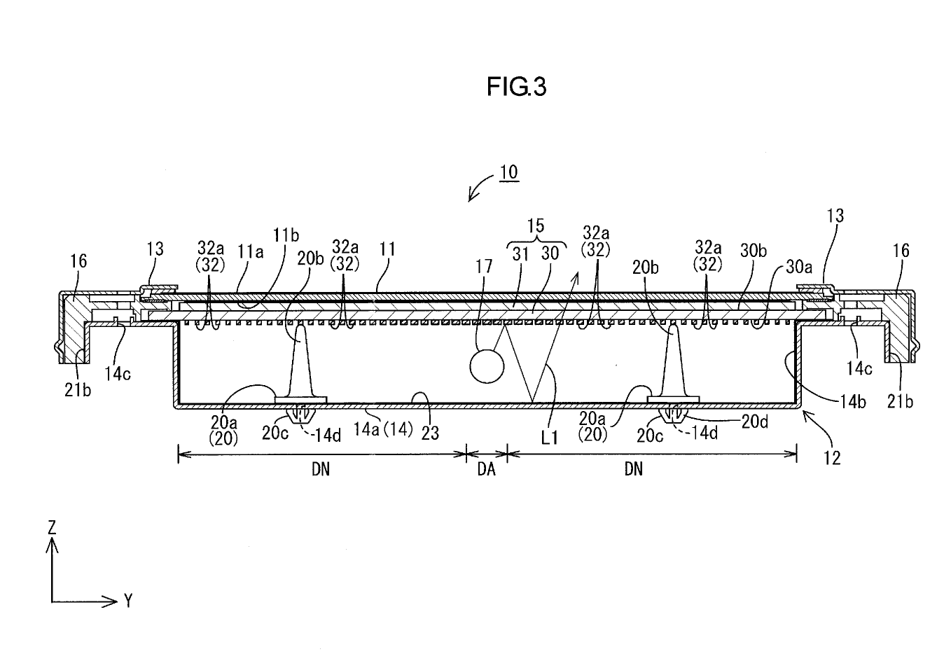

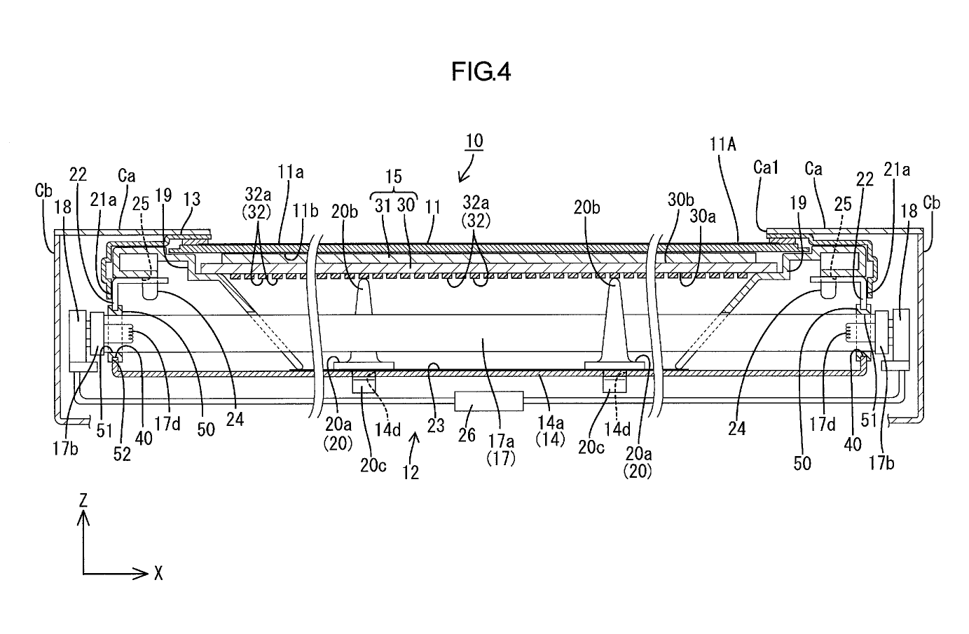

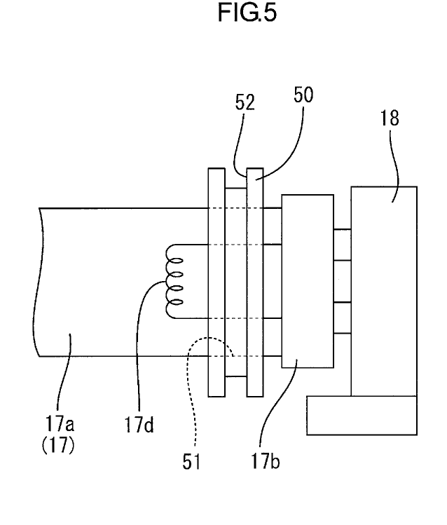

Embodiment 1 of the present invention is described with reference to FIGS. 1 to 8. Firstly, the configuration of a television receiver TV including a liquid crystal display device 10 is described. FIG. 1 is an exploded perspective view showing a schematic configuration of the television receiver TV according to this embodiment; FIG. 2 is an exploded perspective view showing a schematic configuration of the liquid crystal display device included in the television receiver of FIG. 1; FIG. 3 is a cross-sectional view showing a sectional configuration of the liquid crystal display device of FIG. 2, taken along a direction parallel to the short sides thereof; and FIG. 4 is a cross-sectional view showing a sectional configuration of the liquid crystal display device of FIG. 2, taken along a direction parallel to the long sides thereof. Note that this description assumes that the X-axis direction represents a direction parallel to the long sides of the chassis, and that the Y-axis direction represents a direction parallel to the short sides of the chassis.

As shown in FIG. 1, the television receiver TV according to this embodiment is configured by including the liquid crystal display device 10, a power source P, a tuner T and a stand S. The liquid crystal display device 10 (a display device) as a whole has a horizontally-long quadrangular shape (a rectangular shape), and is housed in a stand-up state. As shown in FIG. 2, this liquid crystal display device 10 includes a backlight unit 12 (a lighting device), which is an external light source, and a liquid crystal panel 11 (a display panel). The liquid crystal display device 10 is configured such that these components are integrally supported via a frame-like bezel 13 and the like. The liquid crystal panel 11 provides display by using light from the backlight unit 12. Additionally, the liquid crystal display device 10 is provided with two front and back cabinets Ca and Cb (housing members) configured to house both of the liquid crystal panel 11 and the backlight unit 12 by sandwiching these components from the front and the back. The cabinet Ca (a frame-like section) has an opening Ca1 through which to expose a display surface 11A of the liquid crystal panel 11. In other words, the cabinet Ca surrounds the opening Ca1.

Next, the liquid crystal panel 11 and the backlight unit 12, which constitute the liquid crystal display device 10, are described (refer to FIG. 3 or 4). The liquid crystal panel 11 has a configuration obtained by joining together a pair of glass substrates with a predetermined gap therebetween and enclosing liquid crystal between the two glass substrates. Provided on one of the glass substrates are switching elements (e.g., TFTs) each connected to a source line and a gate line that intersect at right angles, pixel electrodes connected to the switching elements, an alignment film, and the like. Provided on the other glass substrate are a color filter, on which color sections each being of R (red), G (green), B (blue) or the like are arranged in a predetermined array, a counter electrode, an alignment film, and the like. Note that polarizing plates 11a and 11b are arranged on the outer sides of the two substrates (FIG. 3).

As shown in FIG. 2, the backlight unit 12 includes: a chassis 14, which has an opening 14b in one side thereof having a light exiting surface (one side thereof facing the liquid crystal panel 11) and has a substantially boxlike shape; a group of optical members 15 (a diffuser plate 30, and a plurality of optical sheets 31 arranged between the diffuser plate 30 and the liquid crystal panel 11) arranged in a manner covering the opening 14b of the chassis 14; and frames 16 each arranged along a corresponding one of the long sides of the chassis 14, and supporting a long-side edge section of the diffuser plate 30 with the long-side edge section sandwiched between the chassis 14 and the frame 16.

In the inside of the chassis 14, a hot cathode tube 17 (a discharge tube), which is a light source, and holders 19, which cover end sections of the hot cathode tube 17, are housed. As shown in FIG. 3, in the central part of the inside of the chassis 14 in a direction parallel to the short sides thereof, the hot cathode tube 17 is arranged, as only one hot cathode tube, with the length direction (the axial direction) thereof agreeing with a direction parallel to the long sides of the chassis 14. While the hot cathode tube 17 is attached to the chassis 14 via elastic members 50, opposite ends (ferrules 17b) of the hot cathode tube 17 projects from the chassis 14 and is exposed to the outside thereof as shown in FIG. 4. This configuration is described in detail below. Further, in the inside of the chassis 14, support pins 20 to support the optical members 15 from the back side (one side facing the hot cathode tube 17) thereof are provided. Note that, in the backlight unit 12, one side from the hot cathode tube 17 that faces the optical members 15 is the light exiting side.

The chassis 14 is made of metal. As shown in FIGS. 3 and 4, the chassis 14 is composed of: a bottom panel 14a having a rectangular shape in a plan view; and folded outer marginal sections 21a and 21b standing up from the respective sides of the bottom panel 14a. Sheet-metal forming process is used in forming the chassis 14 into a shallow, substantially boxlike shape opening toward the front (in one side facing the light exiting face). Each of the folded outer marginal sections 21a is folded inward and extends in the direction parallel to the short sides. Each of the folded outer marginal sections 21b is folded substantially into a U shape and extends in the direction parallel to the long sides. As shown in FIG. 3, fixing holes 14c are formed in the upper surfaces of the folded outer marginal sections 21b by drilling, which makes it possible to integrate the bezel 13, the frames 16, the chassis 14 and the like by means of, for example, screws or the like.

Each of the holders 19 covering the end sections of the hot cathode tube 17 is made of synthetic resin, the appearance of which is white, and, as shown in FIG. 2, has a long and narrow, substantially boxlike shape extending in the direction parallel to the short sides of the chassis 14. As shown in FIG. 4, while each of the holders 19 has, on the front face, a stepped surface by which the optical members 15 or the liquid crystal panel 11 may be placed on different steps, the holders 19 are arranged in a state partially overlapping the folded outer marginal sections 21a extending in the direction parallel to the short sides of the chassis 14. The holders 19 thereby constitute, together with the folded outer marginal sections 21a, sidewalls of the backlight unit 12. Insertion pins 24 are provided on and project from surfaces of the holders 19 that face the folded outer marginal sections 21a of the chassis 14, which provides a configuration where the holders 19 are attached to the chassis 14 with the insertion pins 24 inserted into insertion holes 25 formed on the upper surfaces of the folded outer marginal sections 21a of the chassis 14.

A reflection sheet 23 is arranged on an internal surface (on a surface facing the hot cathode tube 17) of the bottom panel 14a of the chassis 14. The reflection sheet 23 is made of synthetic resin, assumes a white color having excellent light reflectance, and is laid down along the internal surface of the bottom panel 14a of the chassis 14 in a manner almost entirely covering the internal surface. As shown in FIG. 3, the long-side edges of the reflection sheet 23 stand up in a manner covering the folded outer marginal sections 21b of the chassis 14 and are set in a state sandwiched between the chassis 14 and the optical members 15. This reflection sheet 23 enables light emitted from the hot cathode tube 17 to be reflected toward the optical members 15.

As shown in FIG. 4, the optical members 15 have a rectangular shape in a plan view similarly to the liquid crystal panel 11 and the chassis 14. The optical members 15 is interposed between the liquid crystal panel 11 and the hot cathode tube 17, and are composed of: the diffusion plate 30 placed in the back side (one side facing the hot cathode tube 17; opposite to the light exiting side) of the optical members 15; and optical sheets 31 arranged in the front side (one side facing the liquid crystal panel 11; the light emitting side) thereof. The diffusion plate 30 has a configuration obtained by dispersing a large number of diffusing particles in a substantially transparent base substrate having a predetermined thickness and made of resin. The diffusion plate 30 has the capability to diffuse light that transmits therethrough, and has a light reflecting capability to reflect light that is emitted from the hot cathode tube 17. The optical sheet 31 has a sheet-like shape having a thickness thinner than that of the diffusion plate 30, and are formed by laminating, in order from the diffusion plate 30, a diffusion sheet, a lens sheet and a reflection type polarizing sheet.

The support pins 20 are configured to support the diffusion plate 30 from the back side, and are made of synthetic resin (for example, made of polycarbonate). The overall appearances of the support pins 20 have a whitish color, such as white, which has excellent light reflectance. As shown in FIGS. 2 to 4, each of these support pins 20 is composed of: a main body section 20a forming a plate-like shape following the bottom panel 14a of the chassis 14; a support section 20b projecting frontward (toward the optical member 15) from the main body section 20a; and an engagement section 20c projecting backward (toward the bottom panel 14a of the chassis 14) from the main body section 20a.

The engaging section 20c includes a pair of elastic engagement pieces 20d, and carries the function of holding the support pin 20 in a state attached to the chassis 14 by engaging with a hole edge on the back side of an attachment hole 14d after both of the elasticity engagement pieces 20d have been inserted through the attachment hole 14d provided on the chassis 14. The support section 20b as a whole has a conical shape, and is set to a length that allows the rounded apex thereof to abut on (or come close to) a surface on the back side of the diffusion plate 30. Thus, when the diffusion plate 30 bends, these support sections 20b can prevent the diffusion plate 30 from bending by supporting the diffusion plate 30 from the back side.

The diffusion plate 30 is formed by dispersedly blending a predetermined amount of diffusing particles that diffuse light into a substantially transparent base substrate made of synthetic resin (for example, made of polystyrene). Thus, the light transmittance and the light reflectance of the diffusion plate 30 as a whole are made substantially uniform. Note that it is preferable to set specific values of the light transmittance and the light reflectance of the base substrate (excluding a light reflecting section 32 to be described later) of the diffusion plate 30 to around 70% and around 30%, respectively. The diffusion plate 30 has a surface (hereinafter referred to as a first surface 30a) facing the hot cathode tube 17, and another surface (hereinafter referred to as a second surface 30b) located on the side opposite to the side having the first surface 30a and facing the liquid crystal panel 11. This description assumes that, out of these surfaces, the first surface 30a is a light entering surface to which the light from the hot cathode tube 17 enters, whereas the second surface 30b is a light exiting surface from which light exits toward the liquid crystal panel 11.

Further, the light reflecting section 32, which forms a dotted pattern assuming a white color, is formed on the first surface 30a constituting the light-entering surface in the diffusion plate 30. The light reflecting section 32 is formed, for example, by arranging a plurality of dots 32a in a zigzag manner (in a zigzag alignment; in a staggered manner), the plurality of dots 32a each having a circular shape in a plan view. The dot pattern constituting the light reflecting section 32 is formed, for example, by being printed on the surface of the diffusion plate 30 with paste containing a metal oxide. Screen printing, ink-jet printing and the like are suitable as means for the printing.

The light reflecting section 32 is configured to have light reflectance higher than the light reflectance of the light reflecting section 32 itself and the in-plane light reflectance of the diffusion plate 30 itself, which are set to, for example, about 75% and about 30%, respectively. Here, this embodiment uses, as the light reflectance of each material, the average of light reflectance values within a measurement diameter, which are obtained by use of a LAV (with a measurement diameter φ at 25.4 mm) of CM-3700d manufactured by Konica Minolta Corporation. Note that a value for the light reflectance of the light reflecting section 32 itself is set to one obtained by forming the light reflecting section 32 all over one surface of the glass substrate and measuring, based on the above measurement means, the one surface having the light reflecting section 32 formed thereon.

The diffusion plate 30 is configured such that, with the dot pattern (the areas of the respective dots 32a) of the light reflecting section 32 being varied, the light reflectance of the first surface 30a facing the hot cathode tube 17 of the diffusion plate 30 is varied along the direction (the Y-axis direction) parallel to the short sides. That is, the diffusion plate 30 is configured such that, in the first surface 30a, the light reflectance of a part (hereinafter referred to as a light source overlapping section DA) overlapping the hot cathode tube 17 is larger than the light reflectance of apart (hereinafter referred to as a light source non-overlapping section DN) not overlapping the hot cathode tube 17. Note that the light reflectance of the first surface 30a of the diffusion plate 30 is made almost invariable and substantially uniform along the direction parallel to the long sides. For the purpose of obtaining the above described distribution in light reflectance, the areas of the respective dots 32a constituting the light reflecting section 32 are determined so that: the areas of the dots 32a in the central part, i.e., apart facing the hot cathode tube 17, of the diffusion plate 30 in a direction parallel to the short sides thereof can be the largest; the areas of the dots 32a can gradually decrease according to how far the respective dots 32a are from the central part; and the areas of the dots 32a in the most marginal part of the diffusion plate 30 in the direction parallel to the short sides thereof can be the smallest. In other words, the areas of the dots 32a are determined so as to gradually decrease according to how far the respective dots 32a are from the hot cathode tube 17.

The diffusion plate 30 having the above described configuration enables light emitted from the hot cathode tube 17 to: directly enter the first surface 30a of the diffusion plate 30, or indirectly enter the first surface 30a after being reflected by the reflection sheet 23, the holder 19, the support pin 20 and the like; then transmit through the diffusion plate 30; and, thereafter, exit toward the liquid crystal panel 11 through the optical sheets 31. Light directly entering from the hot cathode tube 17 accounts for a large portion of light in the light source overlapping section DA which overlaps with the hot cathode tube 17 in the first surface 30a of the diffusion plate 30 through which light emitted from the hot cathode tube 17 enter, whereby the quantity of light in the light source overlapping section DA is relatively large as compared to that in the light source non-overlapping section DN. Therefore, relatively raising the light reflectance of the light reflecting section 32 in the light source overlapping section DA results in reduction in light that enters the first surface 30a, whereby a large quantity of light is reflected and returned into the inside of the chassis 14.

On the other hand, in the first surface 30a, the light source non-overlapping section DN not overlapping the hot cathode tube 17 receives a little quantity of light directly from the hot cathode tube 17, and the quantity of light therein is relatively smaller than that in the light source overlapping section DA. Therefore, relatively lowering the light reflectance of the light reflecting section 32 in the light source non-overlapping section DN makes it possible to promote entrance of light into the first surface 30a. At this time, light reflected into the inside of the chassis 14 by the light reflecting section 32 of the light source overlapping section DA is guided to the light source non-overlapping section DN by the reflection sheet 23 and the like (a ray L1 of FIG. 3), which supplements the quantity of light therein. This makes it possible to secure a sufficient quantity of light that enters the light source non-overlapping section DN.

As mentioned above, changing the reflectance of the diffusion plate 30 in the direction parallel to the short sides makes it possible both to obtain a configuration having the hot cathode tube 17 arranged only in the central part in the direction parallel to the short sides and to smoothen the distribution in brightness of illuminating light from the diffusion plate 30 as a whole, and thus makes it possible to achieve a smooth distribution in illumination brightness of the backlight unit 12 as a whole. Note that means to condition the light reflectance may be alternatively configured such that, while the areas of the respective dots 32a of the light reflecting section 32 are the same, intervals between the dots 32a are varied.

Next, the configuration of the hot cathode tube 17 and a structure for attachment between the hot cathode tube 17 and the chassis 14 are described. As shown in FIGS. 3 and 4, the hot cathode tube 17 as a whole has a tubular shape (a linear shape), and includes a hollow glass tube 17a (a tube section), and the pair of ferrules 17b (power source connection sections) arranged on both end sections of the glass tube 17a. While mercury, rare gas and the like are enclosed in the inside of the glass tube 17a, a fluorescence material is applied to the inner wall surface thereof. To the respective ferrules 17b, filaments 17d arranged inside the glass tube 17a are connected. Note that, in general, the outer diameter size of the hot cathode tube 17 is large as compared to the outer diameter size (for example, about 4 mm) of the cold cathode tube, and is set to, for example, about 15.5 mm.

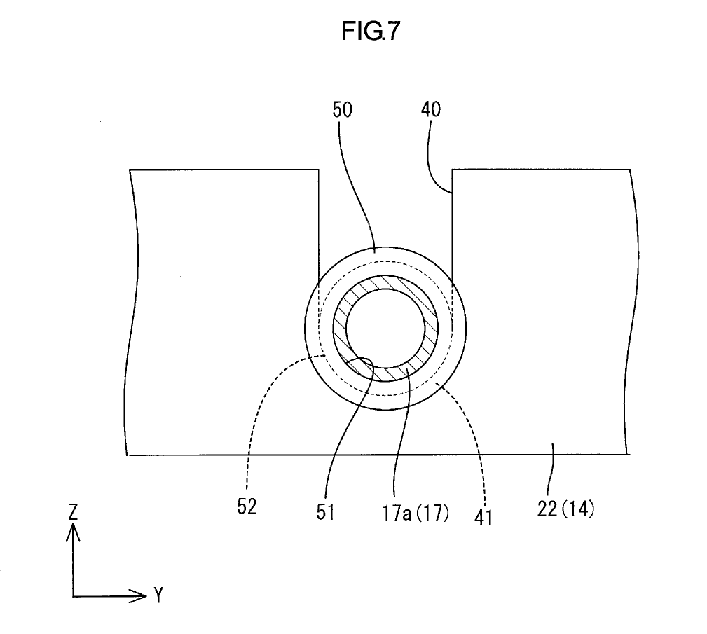

As shown in FIG. 4, a through hole 40 is formed in each of sidewalls 22 (a wall section of the chassis) that constitute the folded outer marginal sections 21a on both sides of the chassis 14 in the longitudinal direction (the X-axis direction) thereof. As shown in FIG. 7, the through hole 40 has a groove-like shape obtained by cutting out a marginal section of the sidewall 22 from the front side (the side facing the light exiting surface, or the upper side in FIG. 7), and penetrates the sidewall 22 in the direction parallel to the long sides. The hot cathode tube 17 is configured to be attachable to the through holes 40 via the respective elastic members 50 in a state penetrating the through holes 40. That is, the through holes 40 are provided as discharge tube attachment sections. The hot cathode tube 17 penetrates both of the through holes 40, thereby having both of the ferrules 17b exposed to the outside of the chassis 14. That is, the hot cathode tube 17 is configured to be partially exposed to the outside of the chassis, and the ferrules 17b are exposed parts of the hot cathode tube 17. Note that, as shown in FIG. 4, both of the ferrules 17b are protected by being housed inside the two front and back cabinets Ca and Cb (in other words, arranged toward the inner side of the cabinet Ca (a frame section)).

Each of the elastic members 50 is arranged between an edge of the corresponding through hole 40 and the hot cathode tube 17, and is made of, for example, silicon gum. As shown in FIG. 7, the elastic member 50 has an annular shape having a tube insertion hole 51 formed inside, and is elastically deformable in the diametric direction thereof. The inner diameter of the tube insertion hole 51 is set substantially equal to or slightly smaller than the outer diameter of the hot cathode tube 17, whereby the hot cathode tube 17 can be inserted through the tube insertion hole 51. The outer diameter A2 of the elastic member 50 is set greater than a width A1 of the through hole 40 in the Y-axis direction. Further, on the outer surface (the circumferential surface) of the elastic member 50 in the diametric direction thereof, a fitting groove 52 extending all over the circumference thereof is concavely provided. This fitting groove 52 is configured to be able to fit in with a hole edge 41 of the through hole 40. Further, as shown in FIG. 4, the elastic member 50 is attached to a position, on the outer circumferential surface of the hot cathode tube 17, between the filament 17d and the ferrule 17b in the axial direction (the X-axis direction) of the hot cathode tube 17.

Sockets 18 are fitted to the respective ends of the hot cathode tube 17 from the outside, the filaments 17d are connected via the sockets 18 to an inverter board 26 (a power source) attached to the outer surface (the back side) of the bottom panel 14a of the chassis 14. While driving power is supplied to the hot cathode tube 17 from the inverter board 26, the inverter board 26 is enabled to control a tube current value, namely, brightness (the state when the lighting is on).

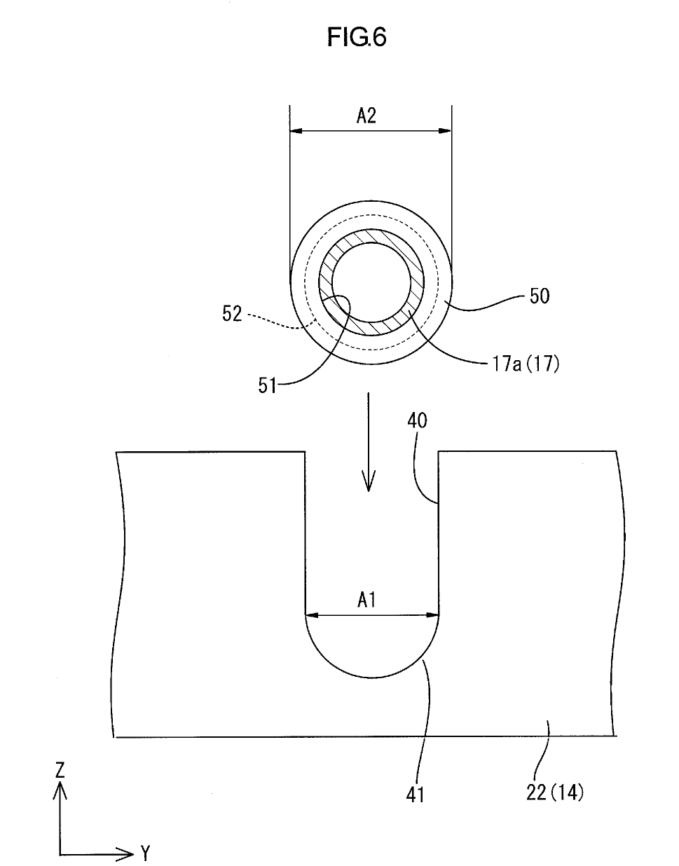

Next, a procedure for attachment of the hot cathode tube 17 to the chassis 14 is described. First of all, the respective elastic members 50 are attached to both ends (more specifically, positions between the respective filaments 17d and corresponding ones of the ferrules 17b) of the hot cathode tube 17. Specifically, the hot cathode tube 17 is inserted into the tube insertion holes 51 of the respective elastic members 50. The inner circumferential surface of each of the elastic members 50 and the outer circumferential surface of the hot cathode tube 17 thereby comes in contact with each other without a gap therebetween. Then, as shown in FIG. 6, the respective elastic members 50 are inserted from the front side (the opening side of the chassis 14) to the through holes 40, and the fitting grooves 52 of the respective elastic members 50 are caused to fit in with the hole edges 41 of the through holes 40. The hot cathode tube 17 is thereby attached to both of the through holes 40 via both of the elastic members 50 as shown in FIG. 4.

Next, the operation and effect obtained when the hot cathode tube 17 is switched on in the backlight unit 12 of this embodiment are described. First of all, when driving power is supplied from the inverter board 26 to the hot cathode tube 17, electricity is discharged from the filaments 17d of the hot cathode tube 17. Consequently, inside the glass tube 17a, electrons collide with mercury enclosed therein, and, as a result, mercury is activated, whereby ultraviolet rays are radiated. These ultraviolet rays activate the fluorescence material applied to the inner wall surface of the glass tube 17a, whereby visible light is emitted.

As mentioned above, when the hot cathode tube 17 is switched on, temperatures inside the glass tube 17a and around the glass tube 17a rise due to heat generation at the time of current passage. Because this embodiment has a configuration where the ferrules 17b of the hot cathode tube 17 are exposed from the chassis 14, heat dissipation from the ferrules 17b is facilitated, and the spot (coldest spot) that has the lowest temperature in the inside of the hot cathode tube 17 (the glass tube 17a) comes to exist in the vicinity of each of the ferrules 17b. Therefore, it is possible to lower the temperature of the coldest spot at the time of the switch-on as compared to a configuration having the ferrules 17b housed within the chassis 14 which tends to be filled with heat. Heating up of the coldest spot can be thereby prevented.

The temperature of the coldest spot influences a vapor pressure of mercury enclosed in the glass tube 17a, and, by extension, influences the brightness of the hot cathode tube 17. Specifically, as the vapor pressure of mercury rises as the temperature of the coldest spot rises, the amount of ultraviolet rays released from the mercury increases, and the light emission efficiency thereby increases. As the vapor pressure of the mercury rises as the temperature of the coldest spot further rises, the amount of ultraviolet rays released by mercury and then reabsorbed by mercury around the foregoing mercury increases. Then, the amount of ultraviolet rays that hit the fluorescence material decreases, and this decrease impairs the light emission efficiency and lowers the brightness. That is, the hot cathode tube 17 has a characteristic such that, while the brightness thereof is the highest when the temperature of the coldest spot is a certain temperature (appropriate temperature), the brightness decreases as the temperature of the coldest spot becomes either higher or lower than this appropriate temperature. Further, the temperature of the coldest spot rises as the temperature (ambient temperature) of a place in which the hot cathode tube 17 is placed increases.

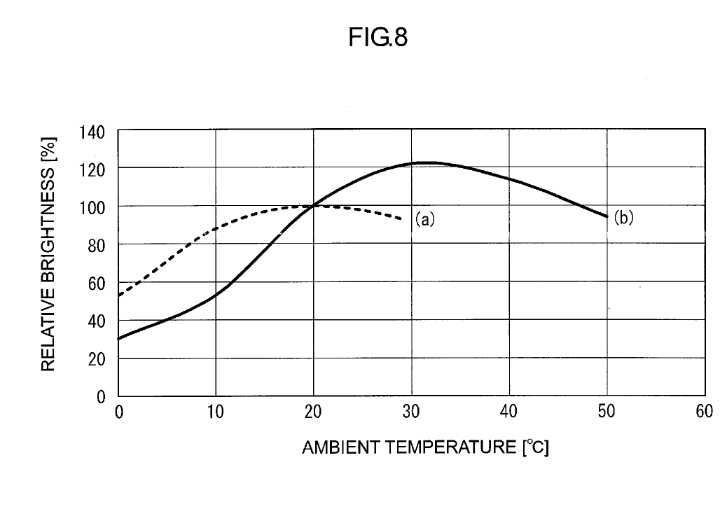

FIG. 8 is a graph showing relations between the temperature (ambient temperature) inside the chassis 14 and the brightness of the hot cathode tube 17. In FIG. 8, a dotted line (a) indicates the brightness of the hot cathode tube 17 having a configuration where the ferrules 17b is housed inside the chassis 14, whereas a solid line (b) indicates the brightness of the hot cathode tube 17 having the configuration of this embodiment. Note that the brightness therein is represented in terms of relative brightness obtained when the brightness in the configuration of (a) under the condition that the ambient temperature is 20° C. is used as a standard (100%). According to FIG. 8, the brightness in the configuration of this embodiment is found higher than the brightness in the configuration of (a) under the condition that the ambient temperature is high. This is because, heat dissipation from the neighborhoods of the ferrules 17b is promoted as a result of the exposure of the ferrules 17b to the outside, so that heating up of the coldest spots is prevented along with the rise of the ambient temperature.

Based upon the foregoing reasons, in this embodiment, prevention of heating up of the coldest spots, and prevention of decrease of the brightness that otherwise accompanies the heating up are made possible by exposing the ferrules 17b of the hot cathode tube 17 from the chassis 14. Note that, in the configuration of this embodiment, the brightness is the highest when the ambient temperature is about 30° C. Under a normal use environment of the television receiver TV, the temperature (ambient temperature) inside the chassis 14 is about 30° C. Therefore, the configuration of this embodiment provides the highest brightness in the normal use environment, and is preferable.

Additionally, the through holes 40 penetrating the sidewalls 22 of the chassis 14 are formed, and the through holes 40 are used as the discharge tube attachment sections configured to receive the hot cathode tubes 17 in the through holes 40 with the hot cathode tubes penetrating the through holes 40. Attachment of the hot cathode tube 17 to the through holes 40 allows the ferrules 17b to be exposed to the outside of the chassis 14.

Further, the elastic member 50 is arranged between the edge of each through hole 40 and the hot cathode tube 17. Arranging the elastic member 50 between the edge of the through hole 40 and the hot cathode tube 17 can improve protection of the hot cathode tube 17.

Further, in the elastic member 50, the fitting groove 52, which can fit in with the hole edge 41 of the through hole 40, is formed. Fitting in of the fitting groove 52 with the hole edge 41 of the through hole 40 allows the elastic member 50, and consequently, the hot cathode tube 17, to be more reliably fixed to the chassis 14.

Additionally, while the chassis 14 has a substantially boxlike shape which is open toward the light exiting surface, the through holes 40 are formed by cutting out marginal sections of the sidewalls 22 of the chassis 14. Thus, attachment of the hot cathode tube 17 to the through hole 40 from the opening side of the chassis 14 is made possible, which improves workability.

Further, the hot cathode tube 17 is used as a discharge tube. Using this configuration makes it possible to achieve higher brightness.

Further, the liquid crystal display device 10 according to this embodiment includes the two front and back cabinets Ca and Cb configured to house the liquid crystal panel 11 and the backlight unit 12. The front cabinet Ca has the opening Ca1, from which to expose the display surface 11A of the liquid crystal panel 11, and has a frame-like shape surrounding the opening Ca1, whereas the ferrules 17b are arranged toward the inner side of the cabinet Ca. Thus, it is made possible to use the cabinets Ca and Cb to protect the ferrules 17b exposed from the chassis 14.

### Embodiment 2

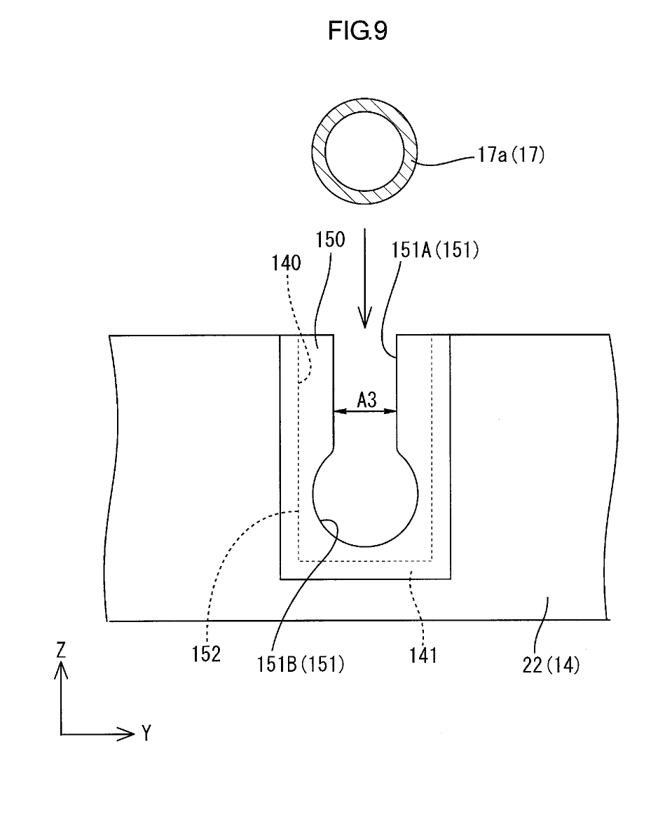

Embodiment 2 of the present invention is described with reference to FIG. 9. In this embodiment, the configurations of an elastic member and a through hole (a discharge tube attachment section) are different from those of Embodiment 1. Parts identical to those of Embodiment 1 are denoted by the same reference signs, and redundant description is not repeated here. A through hole 140 of this embodiment has a rectangular shape, and a rectangular elastic member 150 one size larger than the through hole 140 is attached thereto. On the outer circumference of the elastic member 150, a fitting groove 152 is concavely provided, and this fitting groove 152 is set in a state fitting in with a hole edge 141 of the through hole 140.

A tube insertion hole 151 is formed inside the elastic member 150. The tube insertion hole 151 is composed of a groove section 151A formed by forming an opening in a marginal section of the elastic member 150 from the front side, and a circular section 151B communicating with the groove section 151A. A width A3 of the groove section 151A in the direction parallel to the short sides (the Y-axis direction) is set smaller than the outer diameter of the hot cathode tube 17, and the inner diameter of the circular section 151B is set to a diameter substantially equal to the outer diameter of the hot cathode tube 17. Additionally, the elastic member 150 is, as in the case of Embodiment 1, made of silicone gum and configured to be elastically deformable in a direction in which the width A3 of the groove section 151A is expanded (both rightward and leftward in FIG. 9).

The above configuration makes it possible, in this embodiment, to attach the hot cathode tube 17 to the tube insertion hole 151 of the elastic member 150 after having attached the elastic member 150 to the through hole 140 of the chassis 14. Specifically, when the hot cathode tube 17 is brought from a state shown in FIG. 9 to a state being inserted into the groove section 151A, the hot cathode tube 17 causes the groove section 151A to elastically deform in a direction in which the width thereof is expanded (both rightward and leftward in FIG. 9). When the hot cathode tube 17 reaches the circular section 151B by further being inserted, the groove section 151A elastically returns to the original state. The hot cathode tube 17 is thereby housed in the circular section 151B. Note that, under the condition that the hot cathode tube 17 are set housed in the circular section 151B, all the part of the hot cathode tube 17 in the circumferential direction thereof, except a part thereof in the upper side in FIG. 9, is in contact with the inner circumferential surface of the circular section 151B.

### Embodiment 3

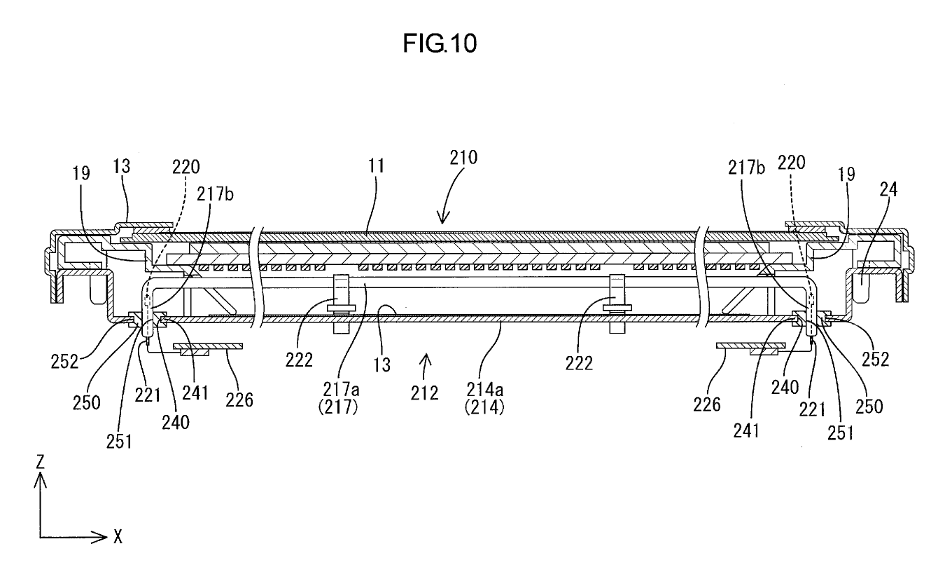

Embodiment 3 of the present invention is described with reference to FIG. 10. In a backlight unit 212 (a lighting device) in a liquid crystal display device 210 (a display device) of Embodiment 3 herein described, a cold cathode tube 217 is used as a discharge tube in place of the hot cathode tube 17. Further, while each of the above embodiments uses a configuration where exposure of the power source connection sections (the ferrules 17b) to the outside of the chassis is implemented by projecting out the end sections of the discharge tube (the hot cathode tube 17) from the sidewalls 22 of the chassis 14, this embodiment uses a configuration where end sections of a discharge tube are projected from a bottom panel of a chassis. Note that parts identical to those of the above embodiments are denoted by the same reference signs, and redundant description is not repeated here.

A cold cathode tube 217 (a discharge tube) is housed with the longitudinal direction thereof (the axial direction) agreeing with a direction parallel to the long sides of the chassis 214. The cold cathode tube 217 includes a hollow, long and narrow glass tube 217a, and a pair of electrodes 220 enclosed on the inner sides of end sections 217b of the glass tube 217a. In the glass tube 217a, each of the end sections 217b on both sides is bent backward, and is U-shaped as a whole. While mercury, rare gas and the like are enclosed in the glass tube 217a, a fluorescence material is applied to the inner wall surface thereof. The end sections 217b of the glass tube 217a are provided with lead terminals 221 (power source connection sections) connected to electrodes 220 and projecting to the outside of the glass tube 217a.

In a bottom panel 214a of a chassis 214 (a bottom wall section of the chassis), through holes 240 are formed at positions corresponding to the end sections 217b of the glass tube 217a in a manner penetrating the bottom panel 214a in the frontward and backward direction. Elastic members 250 are mounted on the respective through holes 240, and the end sections 217b of the glass tube 217a are inserted in tube insertion holes 251 formed in the elastic members 250. Note that, while the through holes 40 and 140 in Embodiments 1 and 2 described above are groove-like holes formed by cutting out marginal sections in the sidewalls 22 of the chassis, the through holes 240 of this embodiment are holes (through holes) formed by cutting out portions within the wall section of the chassis.

The respective elastic members 250 are arranged between the electrodes 220 and the lead terminals 221 in the cold cathode tube 217, which results in a configuration where the lead terminals 221 are exposed to the outside of the chassis 214. Note that each of the elastic members 250 has substantially the same configuration as the elastic member 50 of Embodiment 1. Specifically, the elastic member 250 has an annular shape, and a fitting groove 252 is formed all over the outer circumferential surface thereof in the circumferential direction. The elastic member 250 is attached to the chassis 214 by setting this fitting groove 252 in a state fitting in with a hole edge 241 of the through hole 240.

The cold cathode tube 217 is connected via the lead terminals 221 to inverter boards 226 (power sources) attached to the outer surface of the bottom panel 14a of the chassis 14, whereby driving of cold cathode tube 217 is made controllable. Note that the outer diameter size of the cold cathode tube 217 is set small as compared to the outer diameter size (e.g., around 15.5 mm) of the hot cathode tube 17 shown in Embodiment 1, and set to, for example, about 4 mm. Further, the chassis 214 is provided with lamp clips 222, and the central section (portion other than the end sections 217b) of the glass tube 217a is gripped by gripping sections thereof, whereby the cold cathode tube 217 can be supported with respect to the chassis 214.

Because the lead terminals 221 are exposed to the outside of the chassis 214 also in the backlight unit 212 of this embodiment, it is possible to prevent the temperature of the coldest spot from rising at the time of having the cold cathode tube 217 switched on, and to prevent the brightness from decreasing due to the rising. Further, the backlight unit 212 of this embodiment has a configuration where the end sections 217b of the cold cathode tube 217 are projected on the back side of the chassis 214. As compared to a configuration where the end sections 217b project from sidewalls, this makes it possible to reduce the length of the backlight unit 212 in a direction parallel to the long sides thereof (along a plane direction thereof).

Further, the cold cathode tube 217 is used as a discharge tube. Using this configuration makes it possible to prolong the life of the light source, and, further, makes it possible to facilitate dimming.

### Embodiment 4

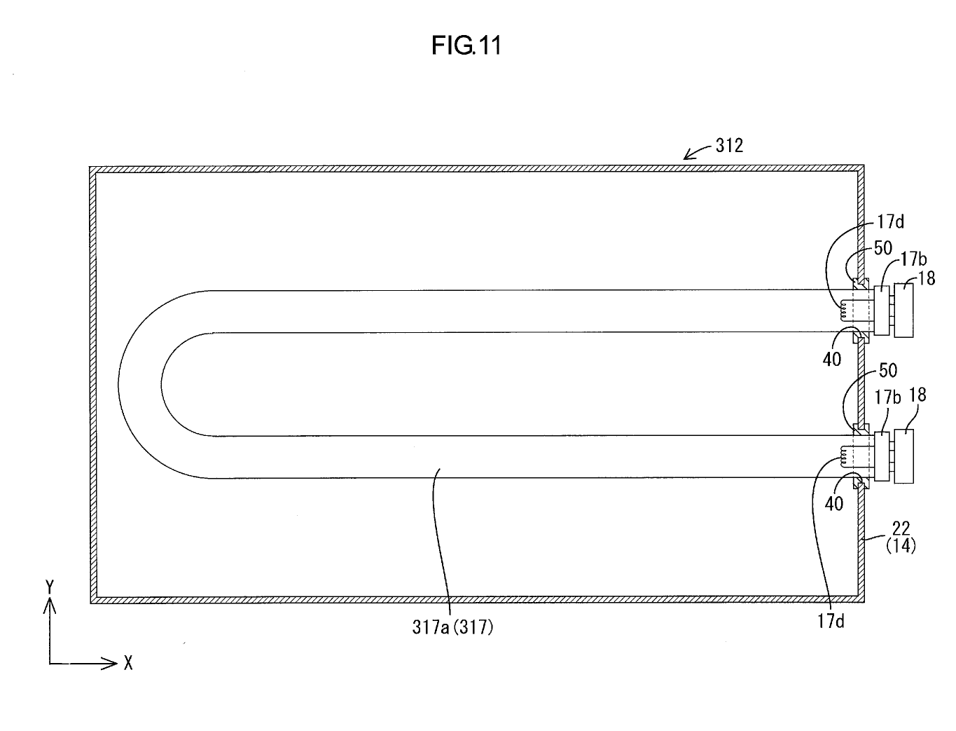

Embodiment 4 of the present invention is described with reference to FIG. 11. In a backlight unit 312 of this embodiment, the shape of a hot cathode tube is different from those of the above respective embodiments. Parts identical to those of the above embodiments are denoted by the same reference signs, and redundant description is not repeated here. The hot cathode tube 317 in this embodiment is a U-shaped tube. That is, the glass tube 317a (a tube section) is U-shaped in a plan view (in a view from the front side of the chassis 14).

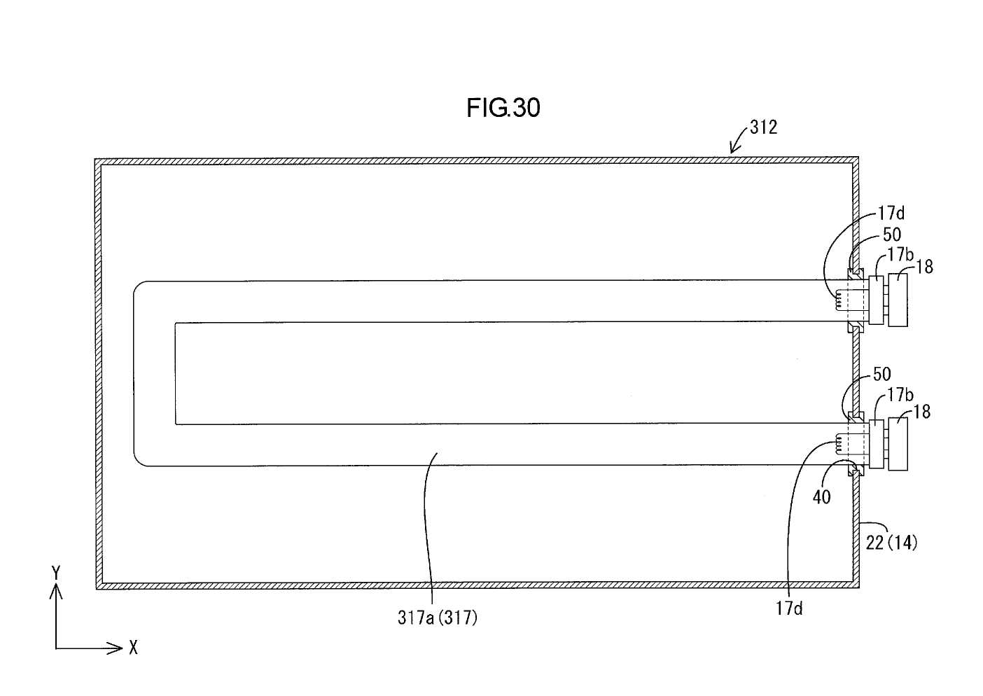

In the sidewall 22 on one side (e.g., the right side of FIG. 11) of the chassis 14, which is one of the sidewalls 22 on both sides in the X-axis direction thereof, the through holes 40 are formed in a manner corresponding to both ends of the hot cathode tube 317. Each of the end sections of the glass tube 317a is attached to a corresponding one of the through holes 40 with the elastic member 50 therebetween. Both of the ferrules 17b of the hot cathode tube 317 are thereby projected and exposed to the outside of the chassis 14. The operation and effect obtained by exposing the ferrules 17b are similar to those in each of the above described embodiments, and description thereof is not repeated here. Note that, as shown in FIG. 30, the shape of the glass tube 317a may have a shape of a katakana “ko”. With the hot cathode tube 317 being U-shaped (or shaped like a katakana “ko”), it is possible to set, only on one end of the chassis 14, positions at which the glass tube 317a is attached to the chassis 14, whereby workability is improved.

### Embodiment 5

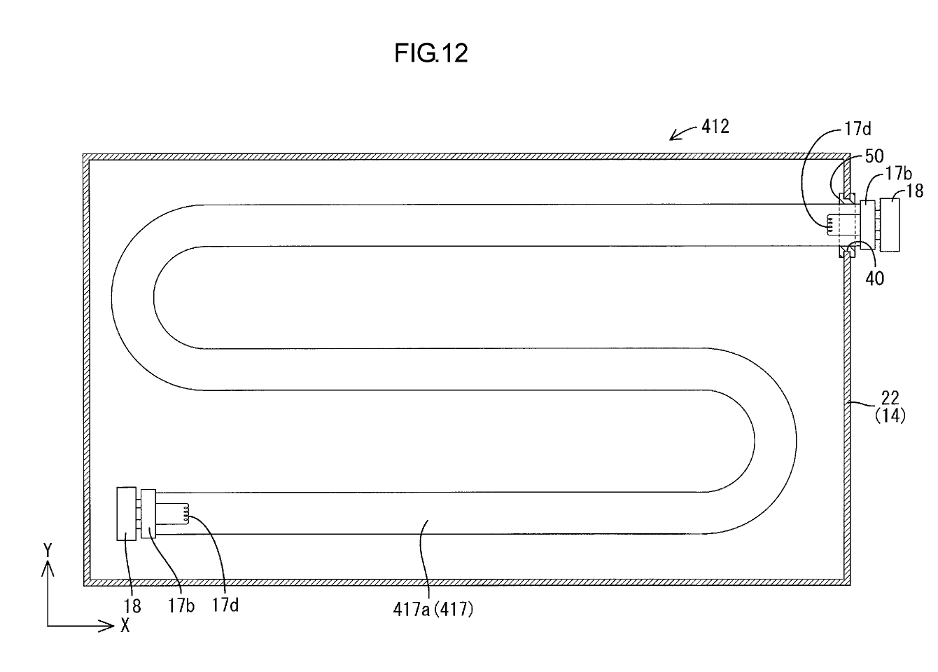

Embodiment 5 of the present invention is described with reference to FIG. 12. In a backlight unit 412 of this embodiment, the shape of a hot cathode tube is different from those of the above respective embodiments. Parts identical to those of the above embodiments are denoted by the same reference signs, and redundant description is not repeated here. The hot cathode tube 417 in this embodiment is a sigmoid tube, and the shape of a glass tube 417a is S-shaped (a meandering shape) in a plan view (in a view from the front side of the chassis 14).

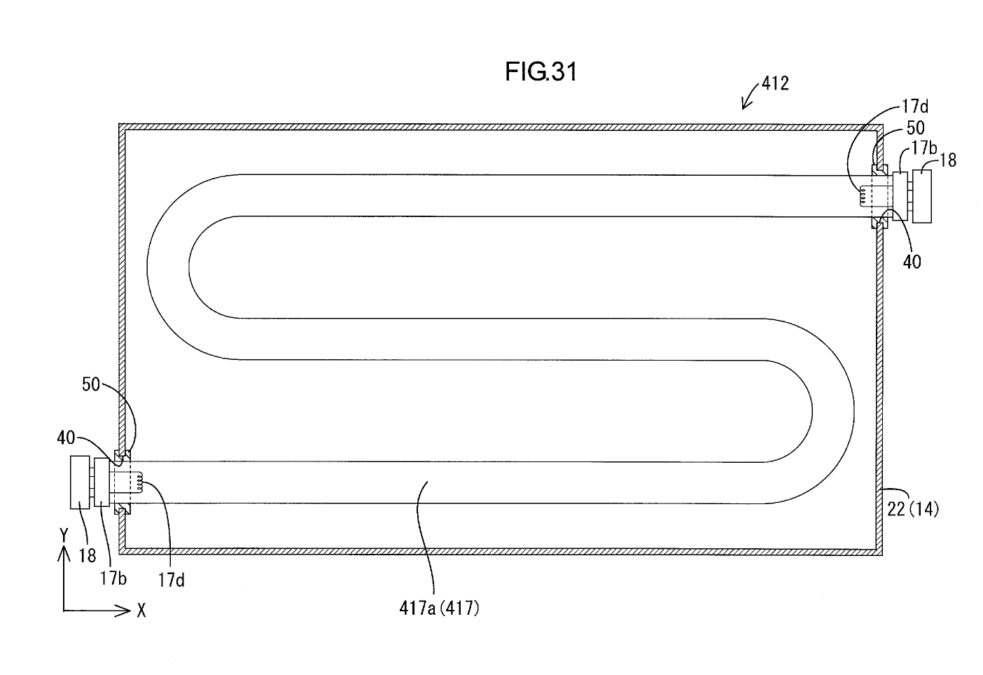

In the sidewall 22 on one side (e.g., the right side of FIG. 12) of the chassis 14, which is one of the sidewalls 22 on opposite sides in the X-axis direction thereof, the through hole 40 is formed in a manner corresponding to one end of the hot cathode tube 417. One of the end sections of the glass tube 417a is attached to the through hole 40 via the elastic member 50. The ferrule 17b of the hot cathode tube 417 is thereby projected and exposed to the outside of the chassis 14. The effect obtained by exposing the ferrule 17b are similar to those in the above described embodiments, description thereof is not repeated here. Note that the shape of the glass tube 417a is not limited to be S-shaped, and may be any shape as long as the shape is a meandering shape. Additionally, as shown in FIG. 31, the configuration may be such that the respective ferrules 17b at both ends of the hot cathode tube 417 are exposed to the outside of the chassis. As compared to a case where the glass tube 417a has a straight shape, the glass tube 417a thus configured to have a meandering shape makes it possible to enlarge, by using only the single hot cathode tube 417, an area (a light emitting area), within the inner surface of the chassis 14 on which the hot cathode tube 417 is arranged.

### Embodiment 6

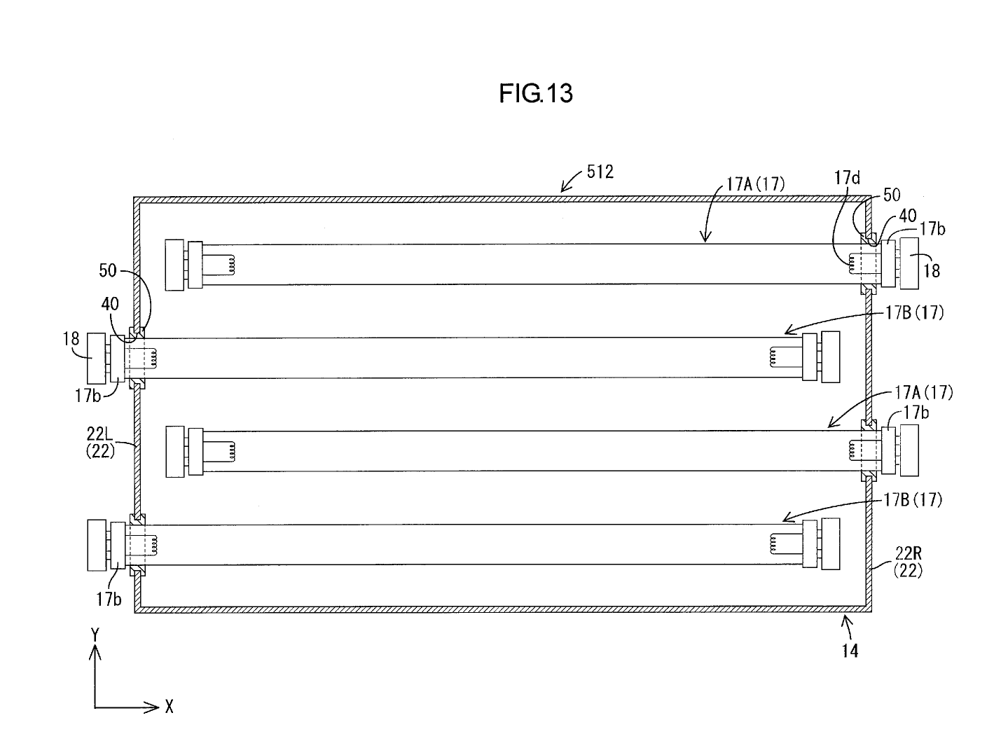

Embodiment 6 of the present invention is described with reference to FIG. 13. Parts identical to those of the above embodiments are denoted by the same reference signs, and redundant description is not repeated here. In the chassis 14 of a backlight unit 512 of this embodiment, the plurality of (e.g., four) hot cathode tubes 17 is arranged in a row in the Y-axis direction. The respective hot cathode tubes 17 are arranged in parallel to the axial directions thereof agreeing with the X-axis direction. In this embodiment, directions toward which the ferrules 17b (exposed parts of the discharge tubes) project are various among the hot cathode tubes 17.

Specifically, the first and third hot cathode tubes 17 (first discharge tubes denoted by a reference sign 17A) downward from the top in FIG. 13 are exposed to the outside of the chassis 14 with the ferrules 17b thereof projecting on one end (the right side in FIG. 13) of the chassis 14 in the direction (the X-axis direction; the width direction) parallel to the long sides thereof. That is, in the hot cathode tubes 17A, the ferrules 17b at the one end projects from the right sidewall 22 (denoted by a reference sign 22R).

On the other hand, the second and fourth hot cathode tubes 17 (denoted by a reference sign 17B, second discharge tubes) downward from the top in FIG. 13 are exposed to the outside of the chassis 14 with the ferrules 17b thereof projecting on the other end (the left side in FIG. 13) of the chassis 14 in the direction parallel to the long sides (the X-axis direction) thereof. That is, in the hot cathode tubes 17B, the ferrules 17b at the other end project from the left sidewall 22 (denoted by a reference sign 22L). In this embodiment, the hot cathode tubes 17A and the hot cathode tubes 17B are arranged alternately in the Y-axis direction. Note that a direction along which the hot cathode tubes 17 are arranged in a row is not limited to the Y-axis direction, and the hot cathode tubes 17 may be arranged in a row, for example, in the X-axis direction. In a case where the hot cathode tubes 17 are arranged in a row in the X-axis direction, it is only required that the above mentioned width direction of the chassis 14 be changed to, for example, the direction parallel to the short sides (the Y-axis direction) of the chassis 14.

### Embodiment 7

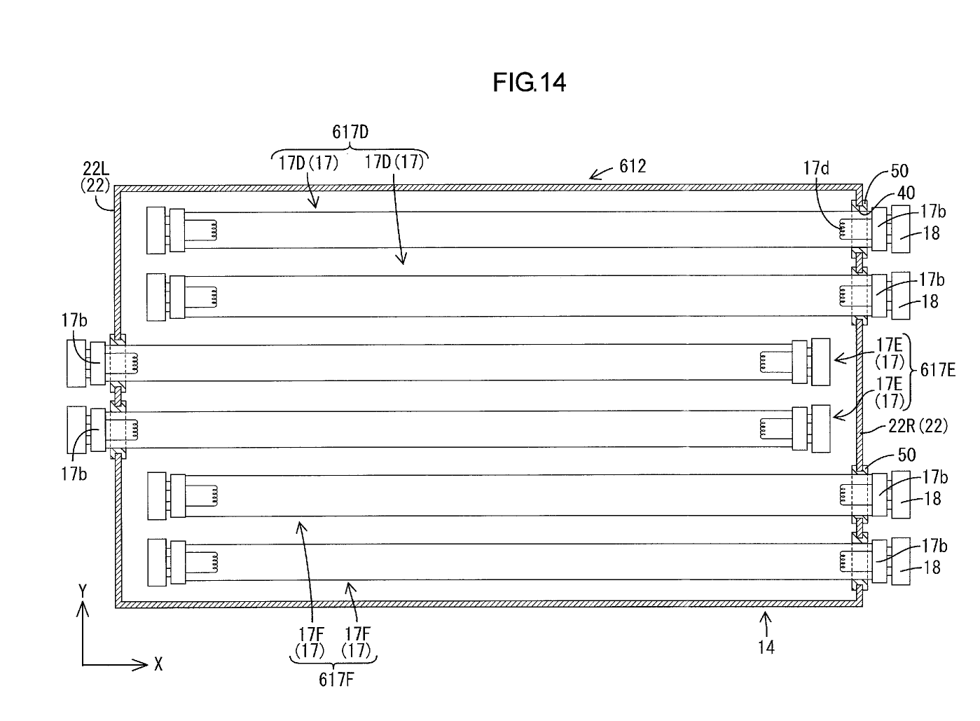

Embodiment 7 of the present invention will be described with reference to FIG. 14. Parts identical to those of the above embodiments are denoted by the same reference signs, and redundant description is not repeated here. In the chassis 14 of a backlight unit 612 of this embodiment, the plurality of (e.g., six) hot cathode tubes 17 is arranged in a row in the Y-axis direction. The respective hot cathode tubes 17 are arranged in parallel to the axial directions thereof agreeing with the X-axis direction. Additionally, directions toward which the ferrules 17b project are various among groups each consisting of the hot cathode tubes 17 (discharge tube groups) that are next to one another.

Specifically, when a group of the first and second hot cathode tubes 17 downward from the top in FIG. 14, a group of the third and the fourth hot cathode tubes 17 downward from the top in FIG. 14, and a group of the fifth and sixth hot cathode tubes 17 downward from the top in FIG. 14 are defined as a discharge tube group 617D (a first discharge tube group), a discharge tube group 617E (a second discharge tube group), and a discharge tube group 617F (another first discharge tube group), respectively, the ferrules 17b of the respective hot cathode tubes 17 (denoted by reference signs 17D and 17F) of the discharge tube group 617D and the discharge tube group 617F are exposed to the outside of the chassis 14 in a manner projecting on one end (the right side in FIG. 14) of the chassis 14 in the direction parallel to the long sides (the width direction) thereof.

On the other hand, the ferrules 17b of the respective hot cathode tubes 17 (denoted by a reference sign 17E) of the discharge tube group 617E are exposed to the outside of the chassis 14 in a manner projecting on the other end (the left side in FIG. 14) of the chassis 14 in the direction parallel to the long sides (the width direction). Additionally, the first discharge tube groups and the second discharge tube group are arranged alternately in the Y-axis direction. Note that any group of the hot cathode tubes 17 that are next to one another is applicable as each of the above described discharge tube groups, which means that the number of the hot cathode tubes 17 constituting each of the discharge tube groups may be changed as appropriate.

### Embodiment 8

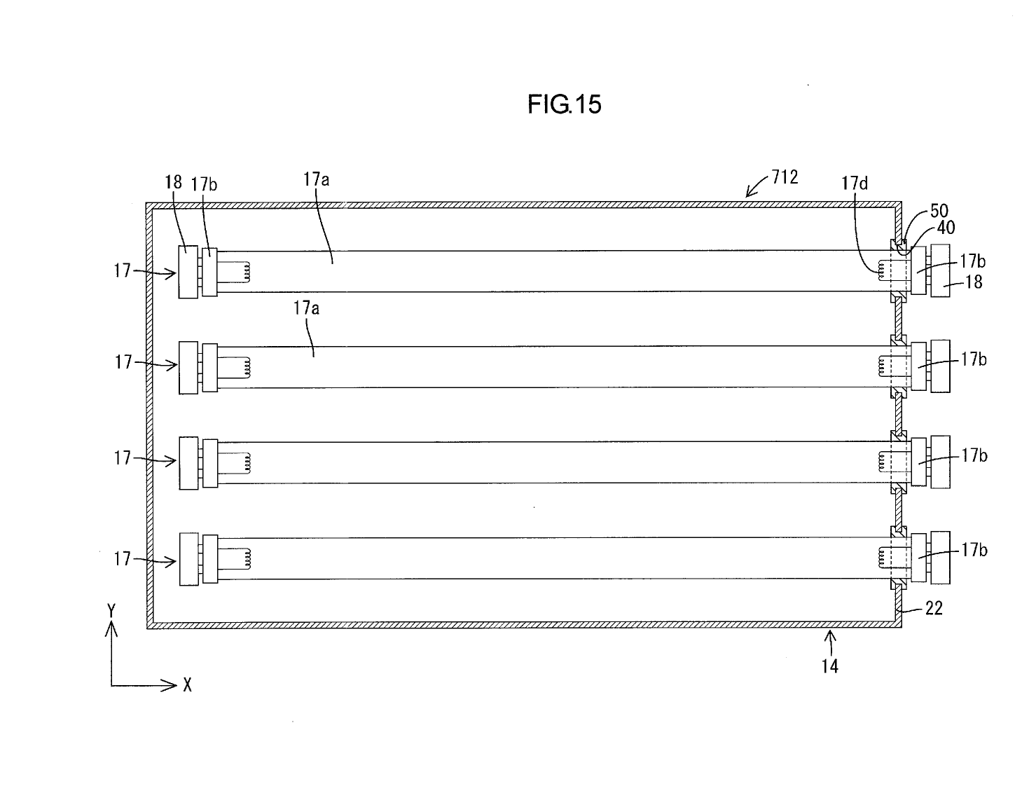

Embodiment 8 of the present invention is described with reference to FIG. 15. Parts identical to those of the above embodiments are denoted by the same reference signs, and redundant description is not repeated here. In the chassis 14 of a backlight unit 712 of this embodiment, the plurality of (e.g., four) hot cathode tubes 17 is arranged in a row in the Y-axis direction. The hot cathode tubes 17 are arranged in parallel to one another with the axial directions thereof agreeing with the X-axis. The ferrules 17b of the respective hot cathode tubes 17 are exposed to the outside of the chassis 14 in a manner projecting on one end of the chassis 14 (in the right side of FIG. 15) in the direction parallel to the long sides (the width direction) thereof. In other words, the ferrules 17b, which are parts exposed to the outside of the chassis 14, are unevenly distributed on one end of the chassis 14.

### Embodiment 9

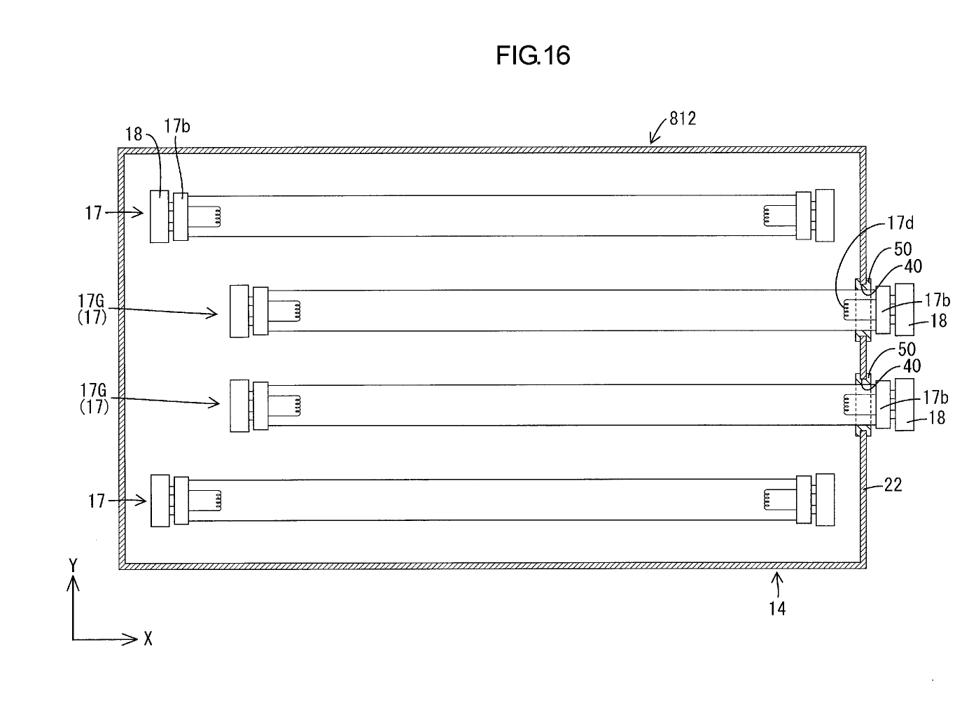

Embodiment 9 of the present invention is described with reference to FIG. 16. Parts identical to those of the above embodiments are denoted by the same reference signs, and redundant description is not repeated here. In a backlight unit 812 of this embodiment, the plurality of (e.g., four) hot cathode tubes 17 is arranged in a row in the chassis 14. The hot cathode tubes 17 are arranged in parallel to one another with the axial directions thereof agreeing with the X-axis. In this embodiment, only the ferrules 17b of the hot cathode tubes 17 (denoted by a reference sign 17G) that are arranged in the central part of the plurality of hot cathode tubes 17 in a direction (the Y-axis direction) along which the plurality of hot cathode tubes 17 is arranged in a row are exposed to the outside of the chassis 14. In a case where the plurality of hot cathode tubes 17 is arranged in a row, heat from the hot cathode tubes 17 in the inside of the chassis 14 tends to gather in, and relatively rises the temperature of, the central part thereof in a direction along which the hot cathode tubes 17 are arranged in a row. Therefore, it is particularly effective to prevent heating up of the coldest spot by exposing the ferrules 17b of only the hot cathode tubes 17G arranged in the central part.

Note that a condition where the hot cathode tubes 17 are arranged in the central part in an arrangement direction (e.g., the Y-axis direction) along which the hot cathode tubes 17 are arranged in a row implies a condition where the hot cathode tubes 17 are arranged to sandwich the hot cathode tubes 17G (on the top and bottom sides of the hot cathode tubes 17G in FIG. 16). Additionally, the number of the hot cathode tubes 17G arranged in the central part may be changed as appropriate.

### Embodiment 10

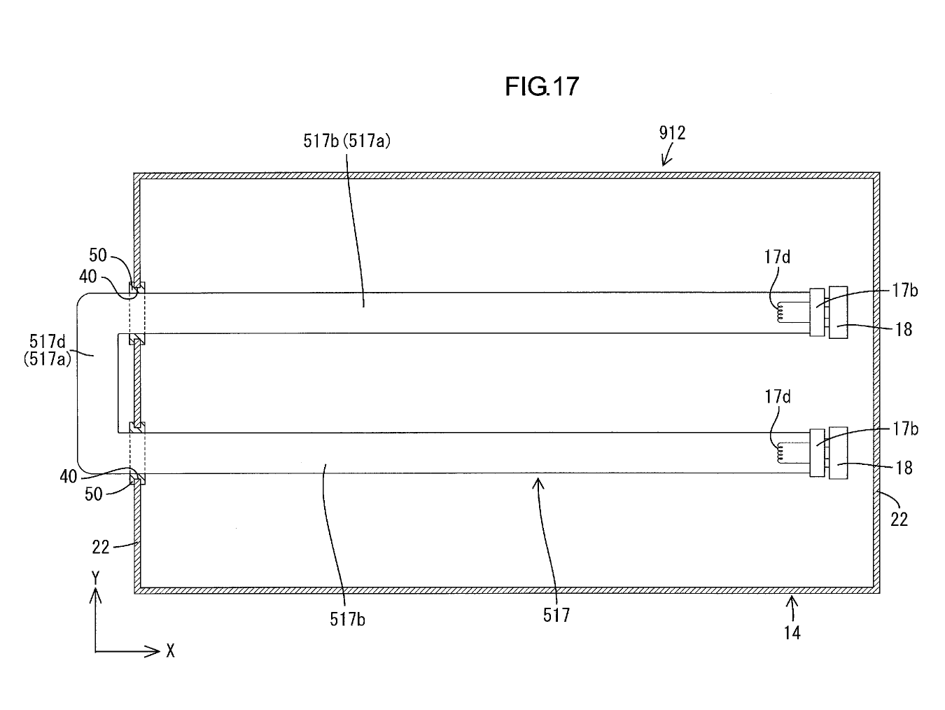

Embodiment 10 of the present invention is described with reference to FIG. 17. Parts identical to those of the above embodiments are denoted by the same reference signs, and redundant description is not repeated here. In a backlight unit 912 of this embodiment, a glass tube 517a of a hot cathode tube 517 is bent into a U shape (or a shape of a katakana “ko”), and is composed of a bent section 517d, and end sections 517b which extend in the X-axis direction from the two ends of the bent section 517d, respectively.

Further, in this embodiment, the through holes 40 formed in the sidewall 22 of the chassis 14 are formed at two positions in a manner corresponding to the respective end sections 517b. The respective end sections 517b are attached to the corresponding through holes 40 via the elastic members 50, whereby a configuration where the bent section 517d (an exposed part of a discharge tube) is exposed to the outside of the chassis 14 is obtained. Using this configuration facilitates heat dissipation from the bent section 517d exposed to the outside of the chassis 14 when the hot cathode tube 517 is illuminated. As a result, the inside of bent section 517d comes to be the coldest spot. As compared to a configuration where the coldest spot is housed in the chassis 14 which tends to be filled with heat, the temperature of the coldest spot at the time of the switch-on can be lowered, whereby decrease in brightness that accompanies the heating up of the coldest spot can be thereby prevented.

### Embodiment 11

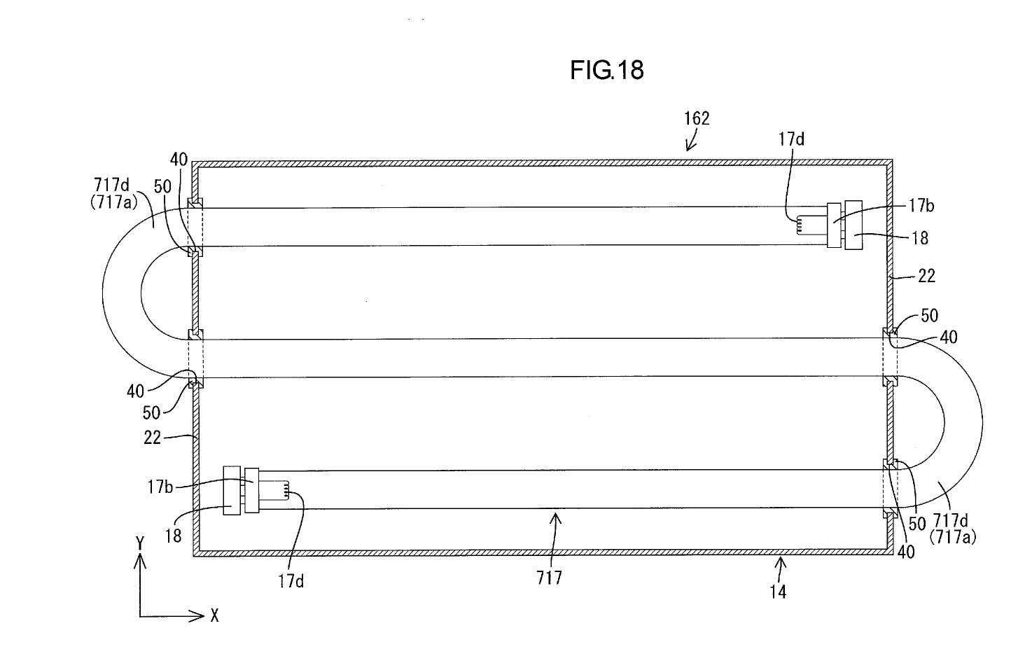

Embodiment 11 of the present invention is described with reference to FIG. 18. Parts identical to those of the above embodiments are denoted by the same reference signs, and redundant description is not repeated here. In a backlight unit 162 of this embodiment, a hot cathode tube 717 is a S-shaped tube, and a shape of a glass tube 717a is S-shaped (a meandering shape) in a plan view (in a view from the front side of the chassis 14). Further, in the S-shape, bent sections 717d formed at two positions are projecting on one and the other ends of the chassis 14, respectively, in the width direction (the X-axis direction) thereof, thereby being exposed to the outside of the chassis 14. In a configuration used by this embodiment, when the hot cathode tube 717 is illuminated, one, out of the bent sections 717d exposed to the outside of the chassis 14, has a lower internal temperature than the other that comes to be the coldest spot. As compared to a configuration where the coldest spot is arranged inside the chassis 14, heating up of the coldest spot can be prevented regardless of which of the two bent sections 717d is found as the coldest spot.

### Embodiment 12

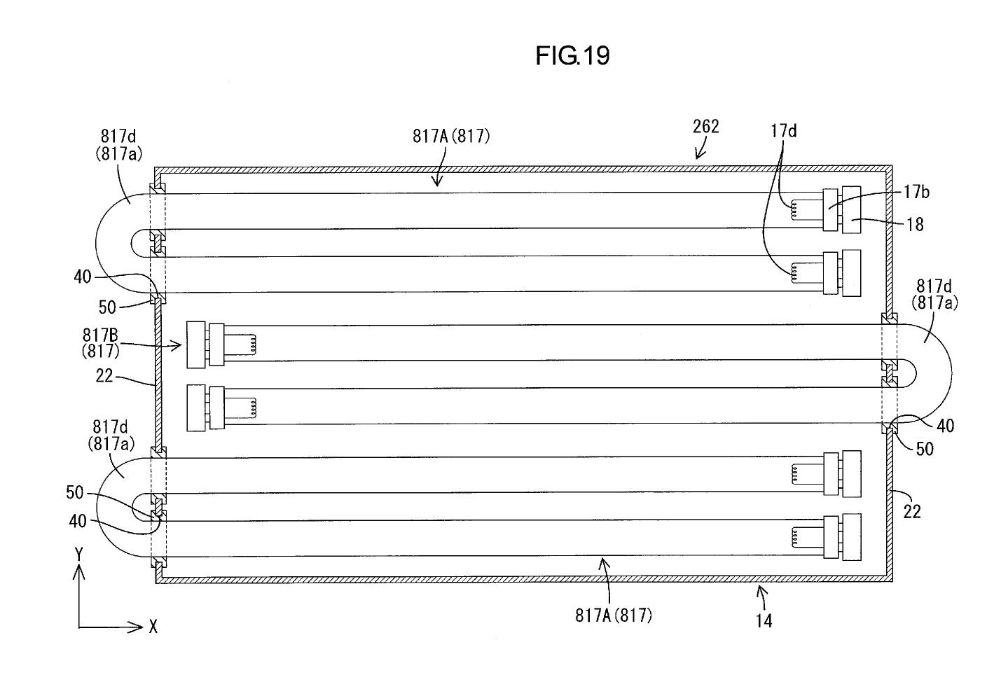

Embodiment 12 of the present invention is described with reference to FIG. 19. Parts identical to those of the above embodiments are denoted by the same reference signs, and redundant description is not repeated here. In the chassis 14 of a backlight unit 262 of this embodiment, the plurality of (e.g., three) hot cathode tubes 817 each being U-shaped is arranged in a row in the Y-axis direction. The hot cathode tubes 817 are arranged in parallel to one another. Specifically, in the first and third hot cathode tubes 817 (denoted by a reference sign 817A; first discharge tubes) downward from the top in FIG. 19, bent sections 817d are exposed to the outside of the chassis 14 in a manner projecting toward the left side (toward one end) of FIG. 19 in the direction parallel to the long sides (the X-axis direction; the width direction) of the chassis 14.

On the other hand, in the second hot cathode tube 817 (denoted by a reference sign 817B; a second discharge tube) downward from the top in FIG. 19, the bent section 817d of the glass tube 817a is exposed to the outside of the chassis 14 in a manner projecting toward the right side (toward the other end) of FIG. 19 in the direction parallel to the long sides (the width direction) of the chassis 14. In this embodiment, the hot cathode tubes 817A and the hot cathode tube 817B are arranged alternately in the Y-axis direction.

### Embodiment 13

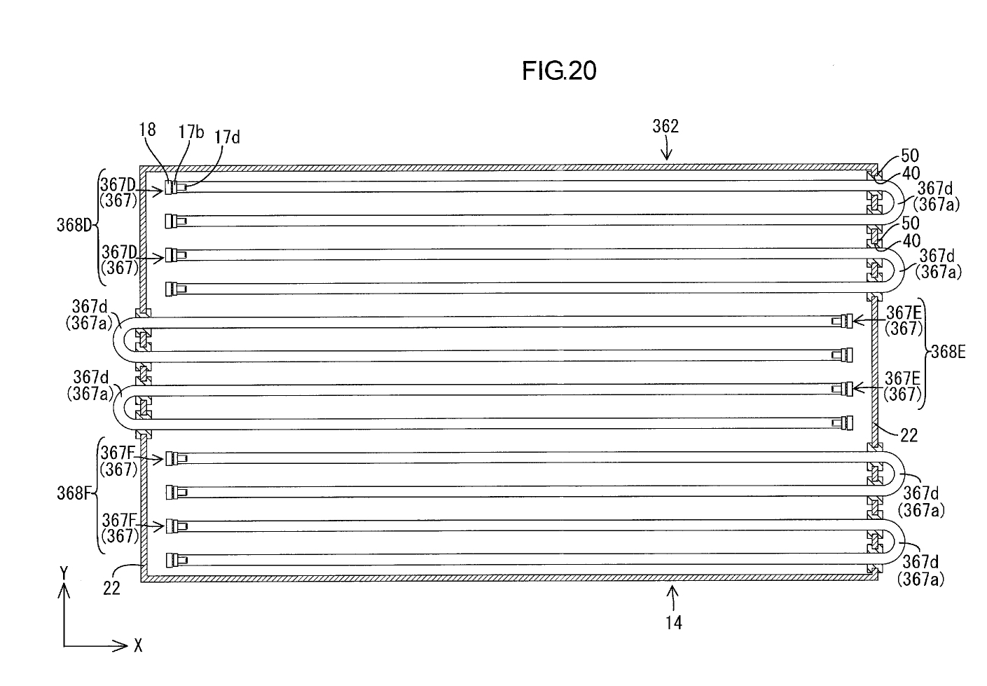

Embodiment 13 of the present invention is described with reference to FIG. 20. Parts identical to those of the above embodiments are denoted by the same reference signs, and redundant description is not repeated here. In the chassis 14 of a backlight unit 362 of this embodiment, the plurality of (e.g., six) hot cathode tubes 367 each being U-shaped is arranged in a row in the Y-axis direction. The hot cathode tubes 367 are arranged in parallel to one another. Further, directions toward which bent sections 367b project are different among groups (group of discharge tubes) of the hot cathode tubes 367 that are next to one another.

Specifically, when a group of the first and second hot cathode tubes 367 downward from the top in FIG. 20, a group of the third and fourth hot cathode tubes 367 downward from the top in FIG. 20, a group of the fifth and sixth hot cathode tubes 367 downward from the top in FIG. 20 are defined as a discharge tube group 368D (first discharge tube group), a discharge tube group 368E (second discharge tube group) and a discharge tube group 368F (another first discharge tube group), respectively, the bent sections 367d in glass tubes 367a of the respective hot cathode tubes 367 (denoted by reference signs 367D and 367F) in the discharge tube group 368D and the discharge tube group 368F are exposed to the outside of the chassis 14 in a manner projecting toward one end (the right side of FIG. 20) in the direction parallel to the long sides (the width direction) of the chassis 14.

On the other hand, the bent section 367d of the hot cathode tubes 367 (denoted by a reference sign 367E) in the discharge tube group 368E are exposed to the outside of the chassis 14 in a manner projecting toward the other end (the left side of FIG. 20) in the direction parallel to the long sides (the width direction) of the chassis 14. Additionally, the first discharge tube groups and the second discharge tube group are arranged alternately in the Y-axis direction. Note that each of the discharge tube groups may include at least two hot cathode tubes 367 that are next to one another and that the number of the hot cathode tubes 367 constituting each of the discharge tube groups may be changed as appropriate.

### Embodiment 14

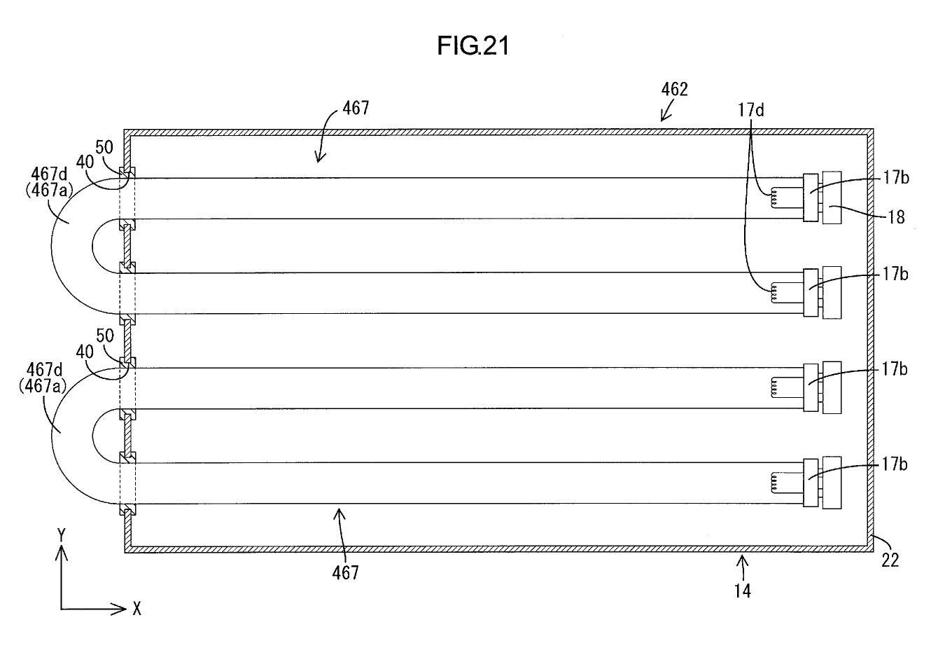

Embodiment 14 of the present invention is described with reference to FIG. 21. Parts identical to those of the above embodiments are denoted by the same reference signs, and redundant description is not repeated here. In the chassis 14 of a backlight unit 462 of this embodiment, a plurality of (e.g., two) hot cathode tubes 467 each being U-shaped is arranged in a row in the Y-axis direction. The hot cathode tubes 467 are arranged in parallel to each other. In the respective hot cathode tube 467, bent sections 467d of glass tubes 467a are exposed to the outside of the chassis 14 in a manner projecting on one end (the left side in FIG. 21) of the chassis 14 in the direction parallel to the long sides (the width direction) thereof. In other words, the respective bent sections 467d, which are parts exposed to the outside of the chassis 14, are unevenly distributed on one end of the chassis 14.

### Embodiment 15

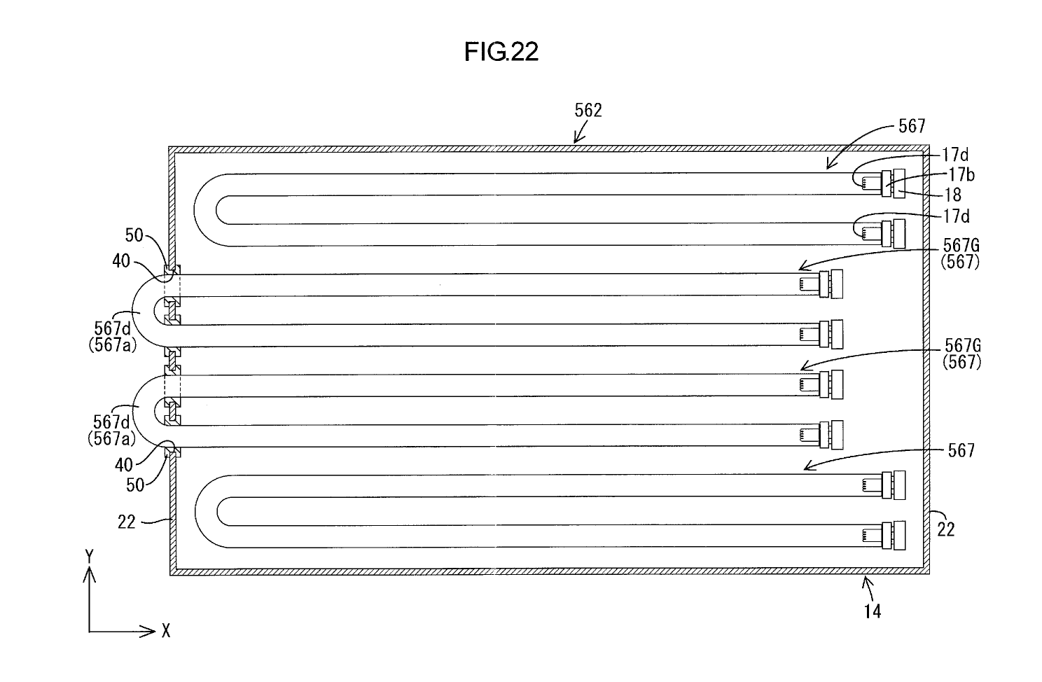

Embodiment 15 of the present invention is described with reference to FIG. 22. Parts identical to those of the above embodiments are denoted by the same reference signs, and redundant description is not repeated here. In the chassis 14 of a backlight unit 562 of this embodiment, a plurality of (e.g., four) hot cathode tubes 567 each being U-shaped is arranged in a row in the Y-axis direction. The hot cathode tubes 567 are arranged in parallel to one another. In this embodiment, only bent sections 567d of glass tubes 567a in the plurality of hot cathode tubes 567 (denoted by a reference sign 567G) that is arranged in the central part of the plurality of hot cathode tubes 567 in a direction (the Y-axis direction) along which the hot cathode tubes 517 are arranged in a row are exposed to the outside of the chassis 14. In a case where the plurality of hot cathode tubes 567 is arranged in a row, the central part in the direction along which the hot cathode tubes 517 are arranged in a row tends to have a relatively higher temperature than the other parts inside the chassis 14. Therefore, it is particularly effective to prevent heating up of the coldest spot by exposing the bent sections 567d in only the hot cathode tubes 567G arranged in the central part.

Note that a condition where the hot cathode tubes 567 are arranged in the central part in an arrangement direction along which the hot cathode tubes are arranged in a row (e.g., the Y-axis direction) implies a condition where the hot cathode tubes 567 are arranged to sandwich the hot cathode tubes 567G (on the top and bottom sides of the hot cathode tubes 567G in FIG. 22). Additionally, the number of the hot cathode tubes 567G arranged in the central part may be changed as appropriate.

### Embodiment 16

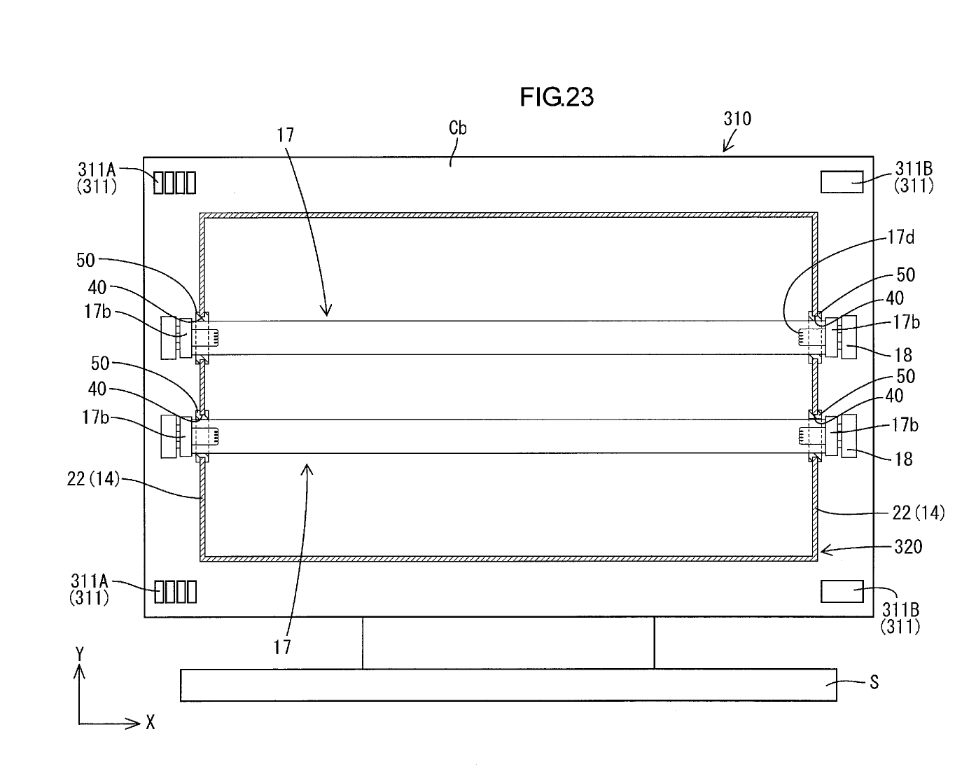

Embodiment 16 of the present invention is described with reference to FIG. 23. Parts identical to those of the above embodiments are denoted by the same reference signs, and redundant description is not repeated here. In a liquid crystal display device 310 of this embodiment, ventilation openings 311 (a cooling mechanism) are formed in the four corners of the rectangular cabinet Cb at the back by penetrating the cabinet Cb in the frontward-backward direction. For example, a slit shape (ventilation openings 311A in the left side) and a rectangular shape (ventilation openings 311B in the right side) can be presented as examples of the shape of each of the ventilation openings 311. Further, a backlight unit 320 of this embodiment is such that, while the chassis 14 includes, for example, the two hot cathode tubes 17, both of the ferrules 17b of each of the hot cathode tubes 17 project into and are exposed to the outside of the chassis 14.

Both of the ventilation openings 311A in the left side in FIG. 23 are aligned along the Y-axis direction, and arranged so as to line up substantially in alignment with the ferrules 17b, in the left sides of the respective hot cathode tubes 17, that project from the sidewall 22 of the chassis 14. Both of the ventilation openings 311B in the right side are aligned along the Y-axis direction, and arranged so as to line up substantially in alignment with the ferrules 17b, in the right side of the respective hot cathode tubes 17, that project from the chassis 22.

According to the above configuration, when the hot cathode tubes 17 are illuminated, air inside the front and back cabinets Ca and Cb is exhausted from the respective ventilation openings 311. This makes it possible to prevent accumulation of heat inside the cabinets Ca and Cb. Heat dissipation from the ferrules 17b can be thereby further facilitated. In other words, the ventilation openings 311 constitute a cooling mechanism by which cooling of the ferrules 17b is enabled.

Further, arranging both of the ventilation openings 311A in alignment with the ferrules 17b makes it more likely that airflows occur around the ferrules 17b in the insides of the cabinets Ca and Cb. Specifically, for example, air having flown into the insides of the cabinets Ca and Cb from the ventilation opening 311A in the lower side is exhausted from the ventilation opening 311A in the upper side after passing through areas surrounding the ferrules 17b located in the left side. This makes it possible to further facilitate heat dissipation from the ferrules 17b, and to more effectively prevent heating up of the coldest spot. The ventilation openings 311 and ferrules 17b in the right side exhibit the same operation and effect as those in the left side. Note that the number of the ventilation openings 311 and a position at which to form each of the ventilation openings 311 are not limited by the configuration of this embodiment, and may be changed as appropriate. Alternately, the ventilation openings 311 may be composed only of the slit-like ventilation openings 311A, or may be composed only of the ventilation opening 311B having rectangular shapes. The shape of each of the respective ventilation openings 311 is not limited to one mentioned in this embodiment, and may be another shape (e.g., a circular shape).

### Embodiment 17

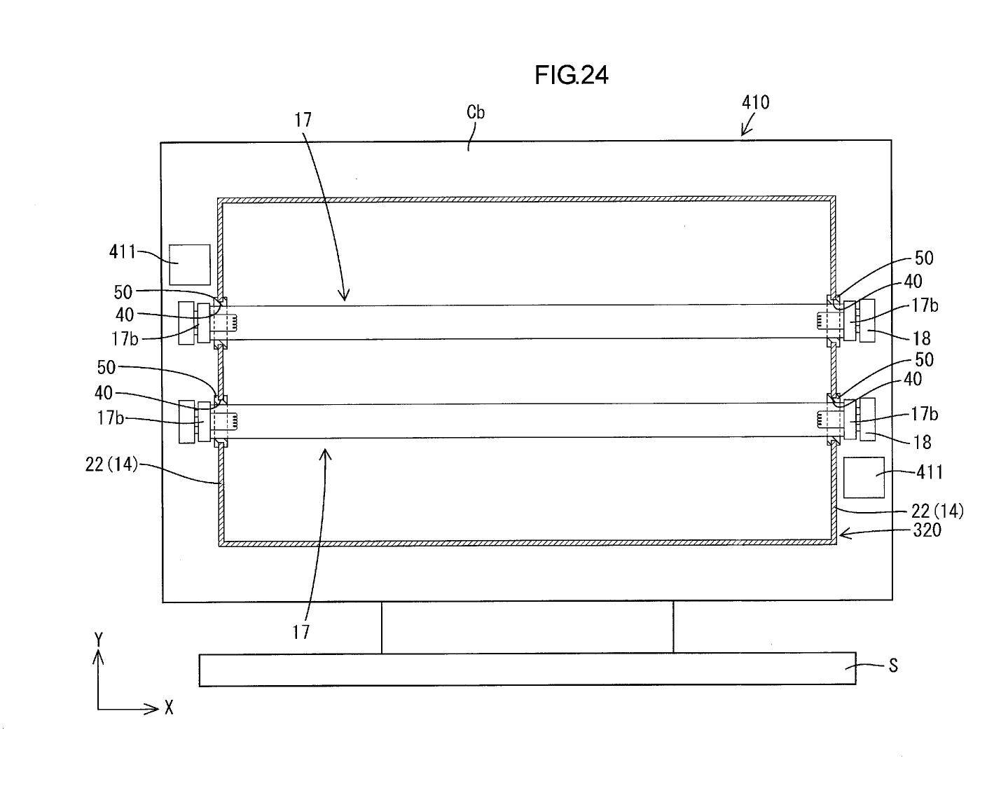

Embodiment 17 of the present invention is described with reference to FIG. 24. Parts identical to those of the above embodiments are denoted by the same reference signs, and redundant description is not repeated here. In a liquid crystal display device 410 of this embodiment, cooling fans 411 (a cooling mechanism) for cooling the ferrules 17b are provided at two positions of the back cabinet Cb. For example, a motor (not illustrated) is connected to each of the cooling fans 411. The configuration is such that air is blown by rotation of the cooling fan 411 when the motor is driven to rotate by receiving power supply from a power source not illustrated. A position at which to attach each of the cooling fans 411 is next to one of the ferrules 17b, and the cooling fan 411 is attached so as to face toward a direction that allows ventilation from the cooling fan 411 to go toward the ferrule 17b. The above configuration makes it possible to, when the hot cathode tubes 17 are illuminated, more effectively cool the ferrules 17b and prevent heating up thereof by driving the cooling fans.

### Embodiment 18

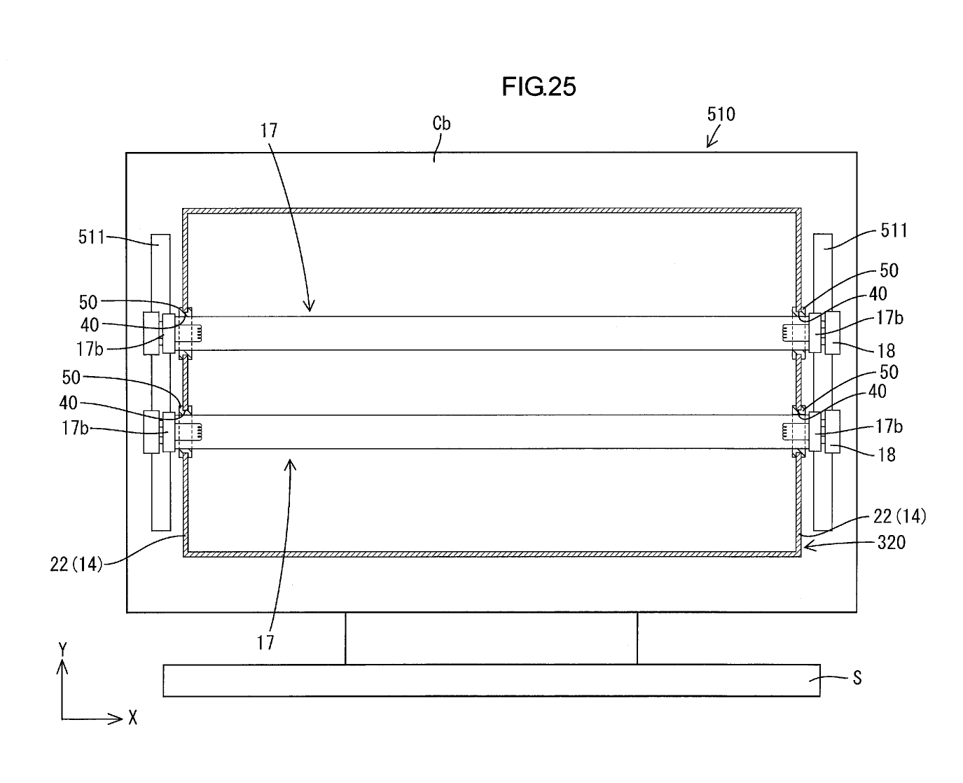

Embodiment 18 of the present invention is described with reference to FIG. 25. Parts identical to those of the above embodiments are denoted by the same reference signs, and redundant description is not repeated here. In a liquid crystal display device 510 of this embodiment, cooling elements 511 (a cooling mechanism) are provided in the back cabinet Cb. For example, Peltier elements are used as the respective cooling elements 511. A power supply not illustrated is connected to each of the cooling elements 511. When an electric current is conducted through the cooling element 511, one surface of the cooling elements 511 absorbs heat, and the other surface thereof produces heat. Note that each of the cooling elements 511 is not limited to a Peltier element.

In this embodiment, the respective cooling elements 511 are installed in a manner corresponding to the ferrules 17b projecting rightward and leftward. More specifically, the heat-absorbing surfaces of the respective cooling elements 511 are in contact with the ferrules 17b, and the heat-producing surfaces thereof are in contact with the cabinet Cb. When electric currents are conducted through the cooling elements 511, heat of the ferrules 17b are absorbed, and the absorbed heat is radiated to the cabinet Cb from the heat-producing surface. Therefore, heating up of the ferrules 17b can be prevented.

### Embodiment 19

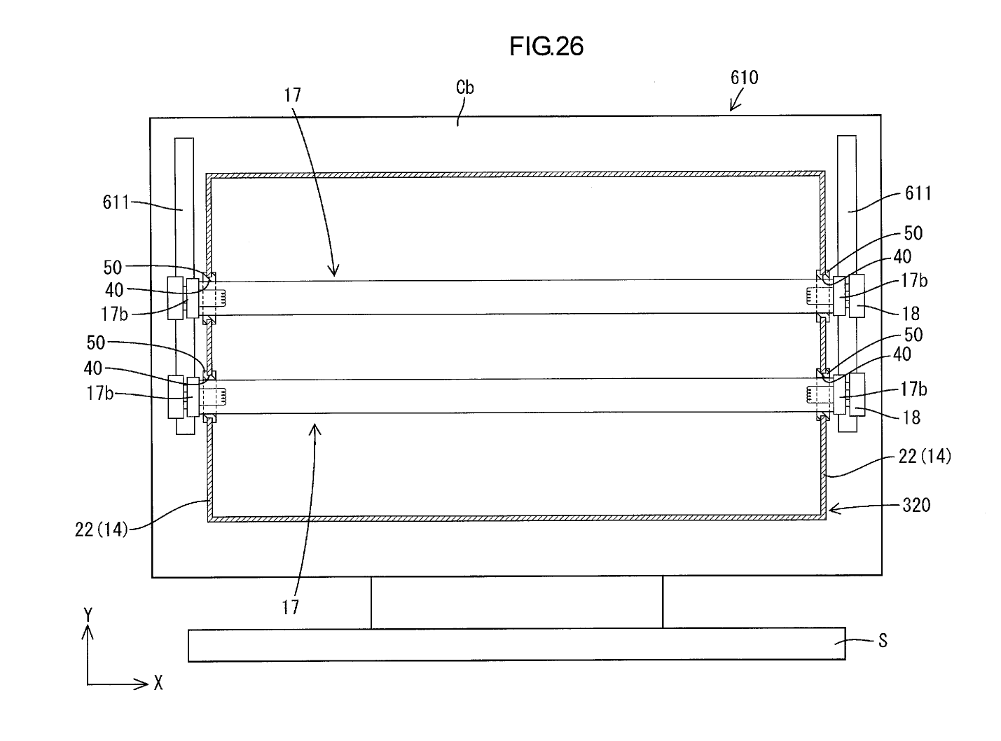

Embodiment 19 of the present invention is described with reference to FIG. 26. Parts identical to those of the above embodiments are denoted by the same reference signs, and redundant description is not repeated here. In a liquid crystal display device 610 of this embodiment, the back cabinet Cb is provided with heat pipes 611 (a cooling mechanism). For example, each of the heat pipes 611 is configured to function as a heat transfer member having an excellent heat transferring capability, and is composed of a pipe made of copper or a copper alloy. For example, water is contained as a refrigerant in the pipe.

As shown in FIG. 26, the respective heat pipes 611 are installed in a manner corresponding to the ferrules 17b projecting rightward and leftward. One end (the lower end in FIG. 26) of each of the heat pipes 611 is in contact with the ferrules 17b, and the other end (the upper end in FIG. 26) thereof is in contact with the cabinet Cb. When heat of the ferrules 17b reaches the heat pipes 611, the heat is transferred toward the cabinet Cb through the insides of the heat pipes 611 by means of latent heat involved in evaporation and condensation of water contained in the heat pipes 611. This makes it possible to more effectively prevent heating up of the ferrules 17b which are the coldest spots.

### Embodiment 20

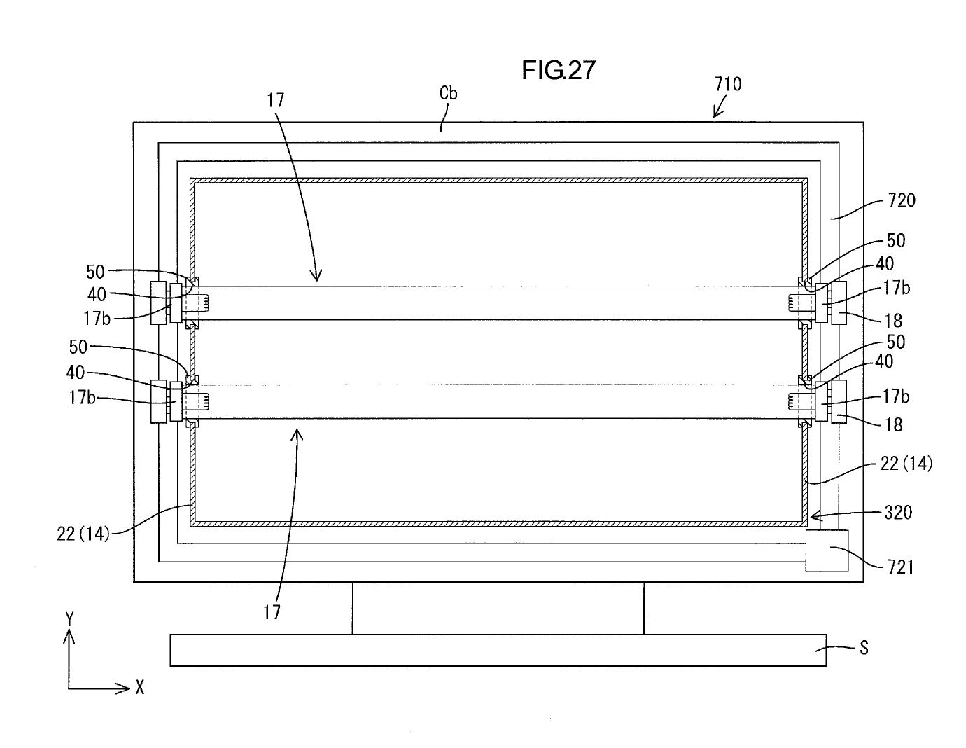

Embodiment 20 of the present invention is described with reference to FIG. 27. Parts identical to those of the above embodiments are denoted by the same reference signs, and redundant description is not repeated here. A circulation pipe 720, water (a refrigerant) enclosed in the inside of the circulation pipe 720, and a refrigerant circulation pump 721 are included, as cooling mechanism, in a liquid crystal display device 710 of this embodiment. The circulation pipe 720 has a substantially frame-like shape, and is arranged in a manner surrounding the chassis 14. Additionally, a part of the circulation pipe 720 is in contact with (or close to) each of the ferrules 17b. The refrigerant circulation pump 721 is connected to the circulation pipe 720, and connected to a power supply not illustrated. This provides a configuration which causes water to circulate through the inside of the circulation pipe 720 when the refrigerant circulation pump 721 is driven.

The above configuration causes water, which is a refrigerant, to circulate through the inside of the circulation pipe 720 when the refrigerant circulation pump 721 is driven. Heat of the ferrules 17b is thereby absorbed by water inside the circulation pipe. The absorbed heat is radiated, for example, to the cabinet Cb as water circulates. This makes it possible to continually cool the ferrules 17b by causing water to circulate, whereby heating up of ferrule 17b can be prevented. Note that some of the cooling mechanisms given as examples in Embodiments 16 to 20 described above may be used and installed inside the cabinets in combination.

### Embodiment 21

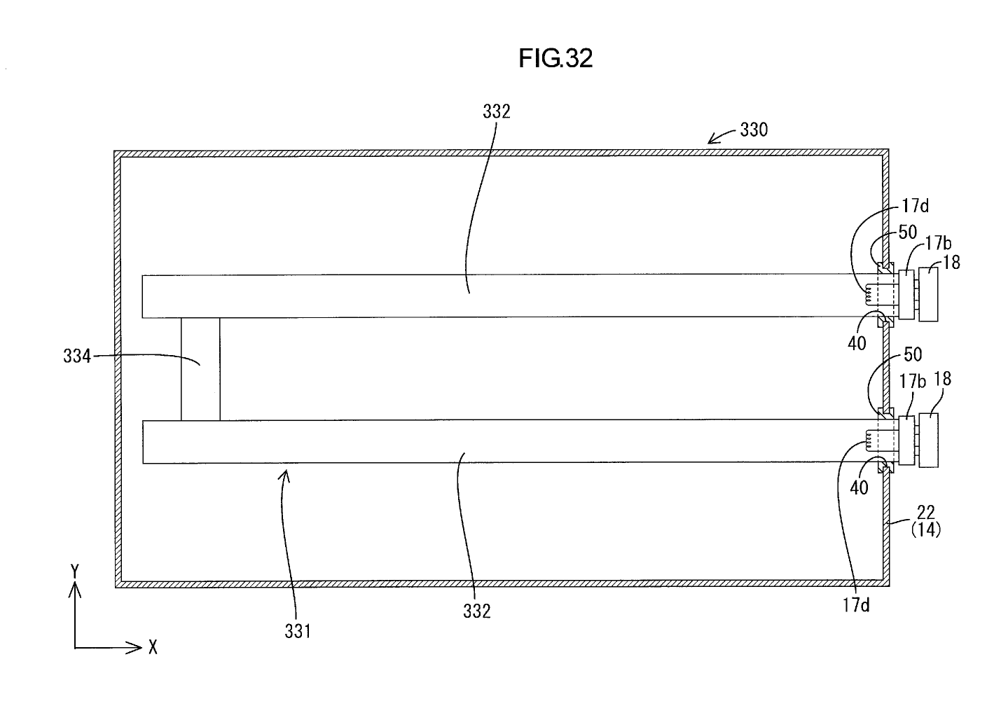

Embodiment 21 of the present invention is described with reference to FIG. 32. Parts identical to those of the above embodiments are denoted by the same reference signs, and redundant description is not repeated here. In a backlight unit 330 of this embodiment, a glass tube in a hot cathode tube 331 is formed by joining together glass tube main body sections (tube sections, hereinafter referred to as main body sections 332) and a glass tube joining section (a tube section, hereinafter referred to as a joining section 334). Specifically, the main body section 332 has a tubular shape, and two main body sections 332 are arranged in parallel to each other with the axial directions thereof matching the longitudinal direction of the chassis 14. The joining section 334 has a tubular shape, and both end sections thereof are fusion-joined to the respective main body sections 332. Thus, the main body sections 332 are coupled together by means of the joining section 334, and the hot cathode tube 331 as a whole is substantially U-shaped. Note that the internal space of the joining section 334 communicates with the internal spaces of the respective main body sections 332.

The ferrule 17b is mounted on one end of each of the main body sections 332. Note that a position at which the joining section 334 is joined to each of the main body sections 332 is set relatively close to one side (the other end), of the main body section 332, on which the ferrule 17b is not mounted. This embodiment has a configuration where the ferrules 17b are exposed to the outside of the chassis 14 through the through holes 40 formed in the chassis 14. The operation and effect obtained by exposing the ferrules 17b are the same as those in each of the above described embodiments, and description thereof is not repeated here. Note that this embodiment gives, as an example, a case where a glass tube is composed of the two main body sections 332 and the joining section 334, but is not be limited thereto and may has a configuration where the main body sections 332 and joining section 334 are joined together in a manner being substantially L-shaped.

### Embodiment 22

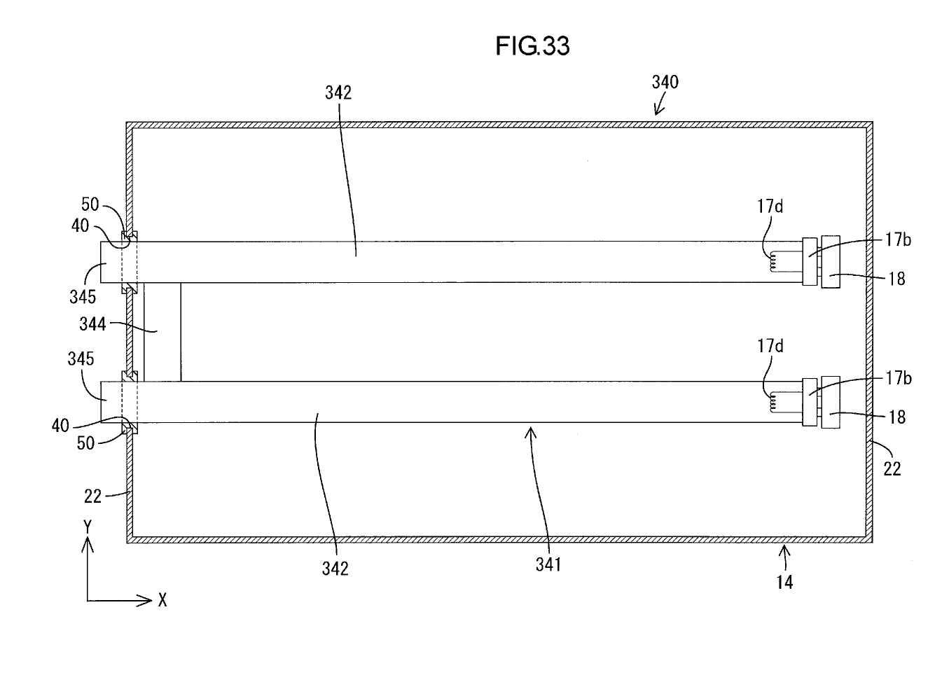

Embodiment 22 of the present invention is described with reference to FIG. 33. Parts identical to those of the above embodiments are denoted by the same reference signs, and redundant description is not repeated here. In a backlight unit 340 of this embodiment, a glass tube in a hot cathode tube 341 is formed by the plurality of fusion-joining tube sections (main body sections 342 and a joining section 344) together as in the case of Embodiment 21. Additionally, in this embodiment, an end section (an exposed part of a discharge tube, hereinafter referred to as exposed sections 345) in a side of each of the main body sections 342 in which the ferrule 17b is not mounted projects from the sidewall 22 of the chassis 14 and is exposed. In other words, in the main body section 342, the exposed section 345 is in the side (the other end) opposite to the side (one end) where the ferrule 17b is mounted.

Heat dissipation from the exposed sections 345 is facilitated by thus exposing the exposed sections 345 to the outside of the chassis 14. As a result, the coldest spots when the hot cathode tube 341 is illuminated come to exist in the inside of the exposed sections 345, which makes it possible to prevent heating up of the coldest spots.

### Embodiment 23

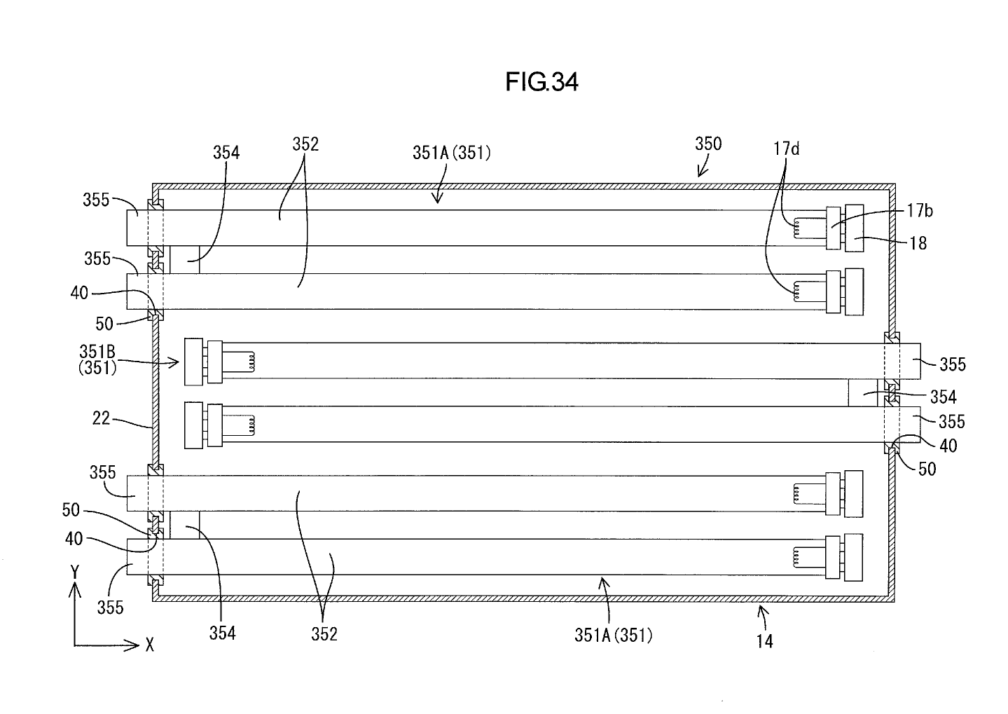

Embodiment 23 of the present invention is described with reference to FIG. 34. Parts identical to those of the above embodiments are denoted by the same reference signs, and redundant description is not repeated here. In a backlight unit 350 of this embodiment, a plurality of (e.g., three) hot cathode tubes 351 is arranged in a row in the Y-axis direction. Each of the hot cathode tubes 351 is configured in the same manner as the hot cathode tubes 341 in Embodiment 22 described above, and, while having main body sections 352 and a joining section 354 joined together, has exposed sections 355 exposed to the outside of the chassis 14. The respective hot cathode tubes 351 are arranged with the main body sections 352 thereof being set parallel to one another.

In the first and third hot cathode tubes 351 (first discharge tubes, denoted by a reference sign 351A) downward from the top in FIG. 34, the exposed sections 355 are exposed to the outside of the chassis 14 in a manner projecting to the left side (one end) of FIG. 34 in the direction parallel to the long sides (the X-axis direction; the width direction) of the chassis 14.

On the other hand, in the second hot cathode tube 351 (second discharge tube, denoted by a reference sign 351B) downward from the top in FIG. 34, the exposed sections 355 are exposed to the outside of the chassis 14 in a manner projecting to the right side (the other end) of FIG. 34 in the direction parallel to the long sides (the width direction) of the chassis 14. In this embodiment, the hot cathode tubes 351A and hot cathode tube 351B are arranged alternately in the Y-axis direction.

### Embodiment 24

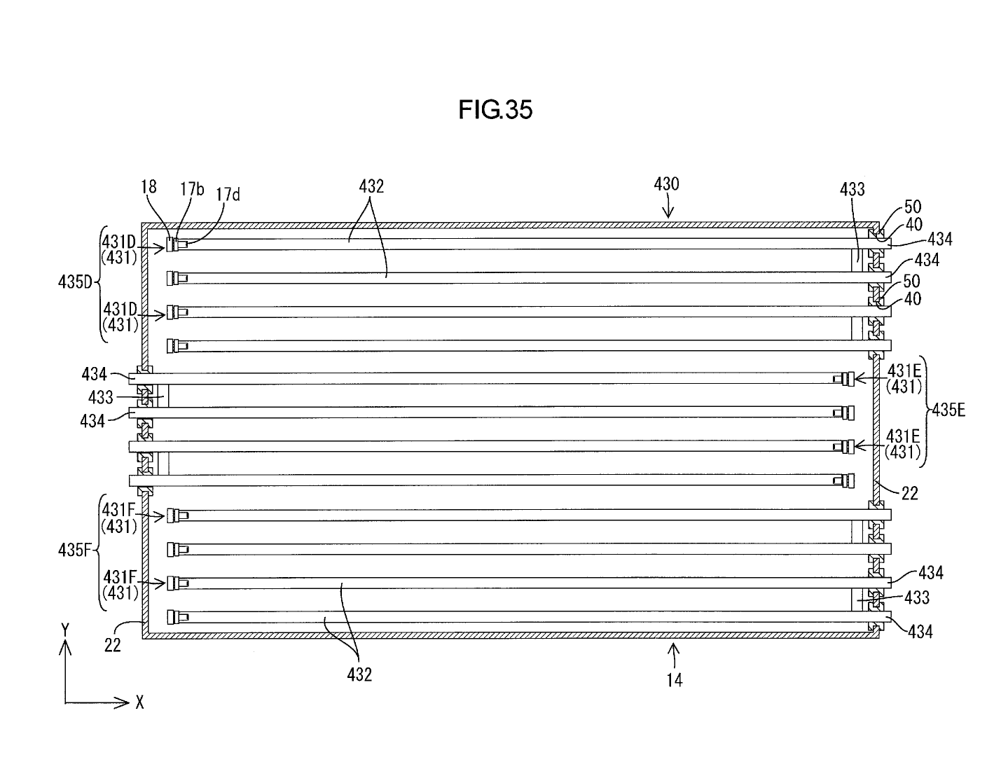

Embodiment 24 of the present invention is described with reference to FIG. 35. Parts identical to those of the above embodiments are denoted by the same reference signs, and redundant description is not repeated here. In a backlight unit 430 of this embodiment, a plurality of (e.g., six) hot cathode tubes 431 is arranged in a row in the Y-axis direction. As in the case of the hot cathode tubes in Embodiments 22 and 23 described above, each of the hot cathode tubes 431 has main body sections 432 and a joining section 433 joined together, and has an exposed section 434 exposed to the outside of the chassis 14. These hot cathode tube 431 are arranged with the respective main body sections 432 thereof being set parallel to each other.

In this embodiment, directions toward which the exposed sections 434 project are different among groups (discharge tube groups) of the hot cathode tubes 431 that are next to each other. Specifically, when a group of the first and second hot cathode tubes 431 downward from the top in FIG. 35, a group of the third and fourth hot cathode tubes 431 downward from the top in FIG. 35, and a group of the fifth and sixth hot cathode tubes 431 downward from the top in FIG. 35, are defined as a discharge tube group 435D (a first discharge tube group), a discharge tube group 435E (a second discharge tube group), and a discharge tube group 435F (another first discharge tube group), respectively, the exposed sections 434 of the main body sections 432 in the hot cathode tubes 431 (denoted by reference signs 431D and 431F) in the discharge tube group 435D and the discharge tube group 435F are exposed to the outside of the chassis 14 in a manner projecting on one end (the right side in FIG. 35) of the chassis 14 in the direction parallel to the long sides (the width direction) thereof.

On the other hand, the exposed sections 434 of the main body sections 432 in the hot cathode tubes 431 (denoted by a reference sign 431E) in the discharge tube group 435E are exposed to the outside of the chassis 14 in a manner projecting on the other end (the left side in FIG. 35) of the chassis 14 in the direction parallel to the long sides (the width direction) thereof. Additionally, the first discharge tube groups and the second discharge tube group are arranged alternately in the Y-axis direction. Note that any group of the two or more hot cathode tubes 431 that are next to one another is applicable as each of the above described discharge tube groups, and that the number of the hot cathode tubes 431 constituting each of the discharge tube groups may be changed as appropriate.

### Embodiment 25

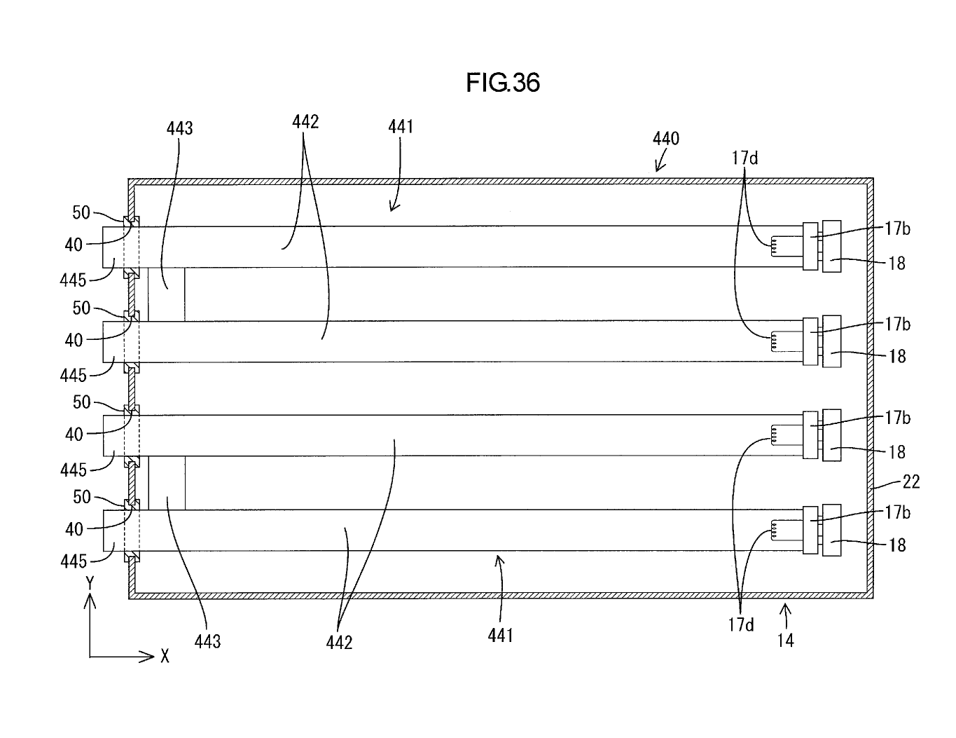

Embodiment 25 of the present invention is described with reference to FIG. 36. Parts identical to those of the above embodiments are denoted by the same reference signs, and redundant description is not repeated here. In a backlight unit 440 of this embodiment, a plurality of (e.g., two) hot cathode tubes 441 is arranged in a row in the Y-axis direction. As in the case of the hot cathode tubes in Embodiments 22 to 24 described above, the configuration of each of the hot cathode tubes 441 is such that main body sections 442 and a joining section 443 are joined together. These hot cathode tubes 441 are arranged with the main body sections 442 thereof being set parallel to one another. In the respective hot cathode tubes 441, the exposed sections 445 in the main body sections 442 are exposed to the outside of the chassis 14 in a manner projecting to one end (the left side in FIG. 36) of the chassis 14 in the direction parallel to the long sides (the width direction) thereof. In other words, exposed sections 445, which are parts exposed to the outside of the chassis 14, are unevenly distributed on one end of the chassis 14.

### Embodiment 26

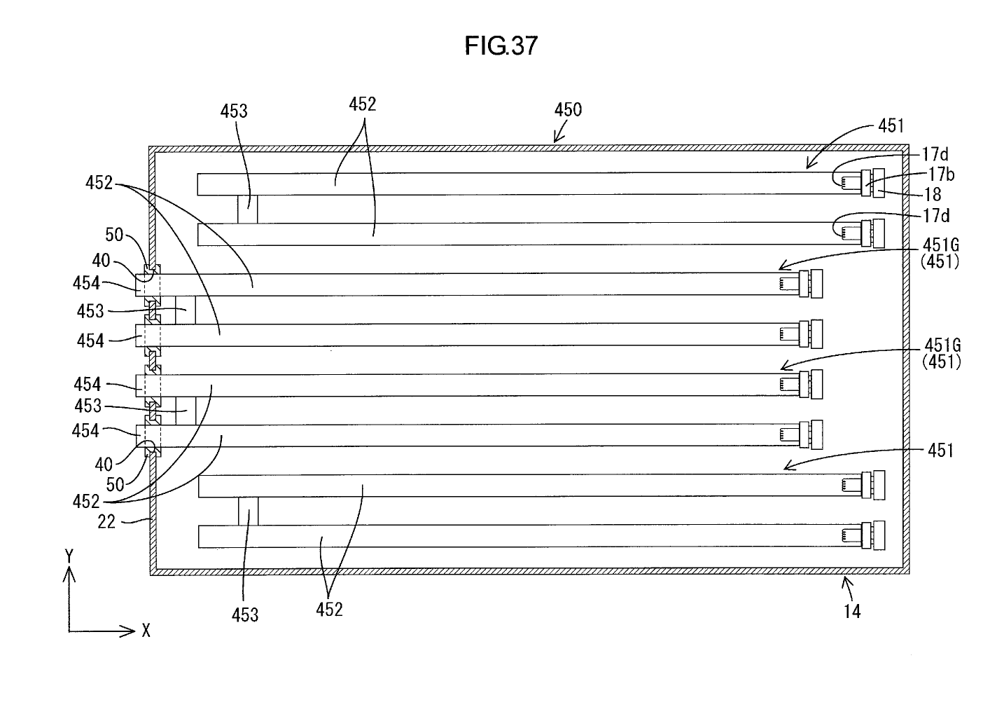

Embodiment 26 of the present invention is described with reference to FIG. 37. Parts identical to those of the above embodiments are denoted by the same reference signs, and redundant description is not repeated here. In a backlight unit 450 of this embodiment, a plurality of (e.g., four) hot cathode tubes 451 is arranged in a row in the Y-axis direction. The configuration of each of the hot cathode tubes 451 is, as in the case of the hot cathode tubes in Embodiments 22 to 25 described above, such that main body sections 452 and a joining section 453 are joined together.

In this embodiment, only one end sections (exposed sections 454) of the respective main body sections 452 in the hot cathode tubes 451 (denoted by a reference sign 451G) that are arranged in the central part of the plurality of hot cathode tubes 451 in a direction (the Y-axis direction) along which the hot cathode tubes 451 are arranged in a row is exposed to the outside of the chassis 14. In a case where the plurality of hot cathode tubes 451 is arranged in a row, the central part of the inside of the chassis 14 in the direction along which the hot cathode tubes 451 are arranged in a row tends to have a relatively high temperature. Therefore, it is particularly effective to prevent heating up of the coldest spots by exposing the exposed sections 454 of only the hot cathode tube 451G arranged in the central part.

Note that a condition where the hot cathode tubes 451 are arranged in the central part in a direction (e.g., the Y-axis direction) along which the hot cathode tubes 451 are arranged in a row implies a condition where the hot cathode tubes 451 are arranged to sandwich the hot cathode tubes 451 in the central part (are arranged on the top and bottom sides in FIG. 37). Additionally, the number of the hot cathode tube 451G arranged in the central part may be changed as appropriate.

### Embodiment 27

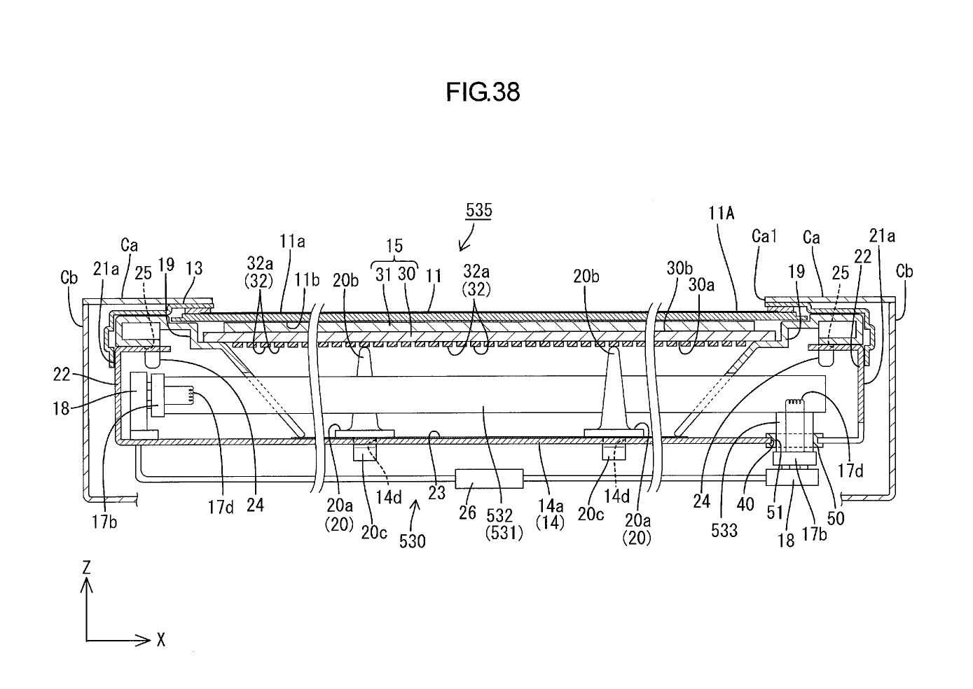

Embodiment 27 of the present invention is described with reference to FIG. 38. Parts identical to those of the above embodiments are denoted by the same reference signs, and redundant description is not repeated here. In a backlight unit 530 in a liquid crystal display device 535 of this embodiment, a glass tube in a hot cathode tube 531 is composed of originally separated elements, which are a main body section 532 extending in the direction parallel to the long sides of the chassis 14, and an end section 533. The end section 533 is fusion-joined to a part of the main body section 532 at one end thereof, and the internal space of the end section 533 communicates with the internal space of the main body section 532. The ferrules 17b are mounted in sides of the main body section 532 and the end section 533 that are opposite to sides in which positions used for the joining thereof are found. The end section 533 is attached to the through hole 40 formed in the bottom panel 14a of the chassis 14 via the elastic member 50, which brings a configuration where the ferrule 17b on the end section 533 is exposed to the outside of the chassis 14.

### Embodiment 28

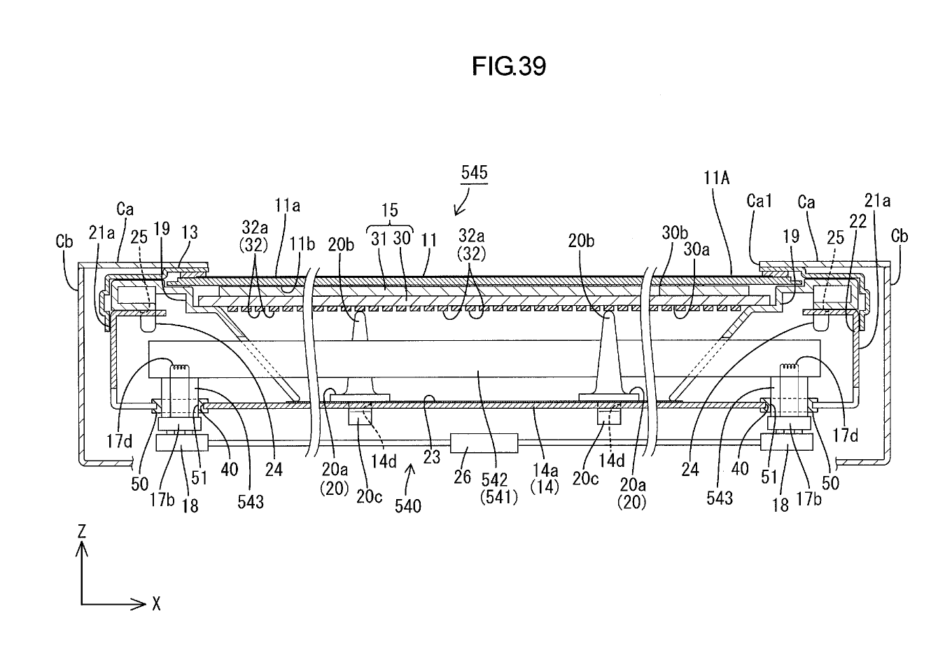

Embodiment 28 of the present invention is described with reference to FIG. 39. Parts identical to those of the above embodiments are denoted by the same reference signs, and redundant description is not repeated here. In a backlight unit 540 in a liquid crystal display device 545 of this embodiment, a glass tube of a hot cathode tube 541 is composed of a main body section 542 extending in the direction parallel to the long sides of the chassis 14, and end sections 543 fusion-joined to the respective end sections of the main body section 542. The internal spaces of the end sections 543 communicate with the internal space of the main body section 542. The ferrules 17b are mounted on end sections of the respective end sections 543 in sides thereof opposite to sides thereof in which positions used for the joining thereof to the main body section 542 (the lower side in FIG. 39) are found. The respective end sections 533 are attached via the corresponding elastic members 50 to the corresponding through holes 40 formed in the bottom panel 14a of the chassis 14, which brings a configuration where the ferrules 17b on the respective end sections 533 are exposed to the outside of the chassis 14.

### Other Embodiment

The present invention is not limited to the above embodiments explained in the above description and drawings. The following embodiments may be included in the technical scope of the present invention, for example.

(1) Although a ferrule or a bent section is given as an example of an exposed part of a discharge tube (a hot cathode tube or a cold cathode tube) in each of the above described embodiments, the present invention is not limited to this. It is only required that the discharge tube be partially exposed. A part of the discharge tube that is different from the above examples may be exposed.

(2) Although a configuration where a discharge tube is attached to a wall section of a chassis is given as an example in each of the above described embodiments, it is not always necessary to attach a discharge tube to a wall section of a chassis. In brief, it is only required that the discharge tube be attached in a manner allowing a power source connection section thereof to be exposed to the outside of the chassis, and a position to which the discharge tube is attached may be changed as appropriate.

(3) Although a configuration where a discharge tube is attached to a chassis via an elastic member is given as an example in each of the above described embodiments, another configuration where a discharge tube is directly attached to a chassis without an elastic member may be alternatively used.

(4) Any through hole which penetrates the chassis in a manner enabling communication between the outer and inner sides thereof, and through which a discharge tube can be inserted is applicable as each of the through holes, and the shape thereof may be changed as appropriate.

(5) In Embodiment 1 described above, although the configuration where the hot cathode tube 17 provided in a manner extending in a direction parallel to the long sides (the X-axis direction) of the chassis 14 is shown, the hot cathode tube 17 may be provided in a manner extending in a direction parallel to the short sides (the Y-axis direction) of the chassis 14. In a case where this configuration is used, it is only required that the configuration be such that the ferrules 17b of the hot cathode tube 17 are projected from the sidewalls on both sides of the chassis 14 in the direction parallel to the short sides thereof.

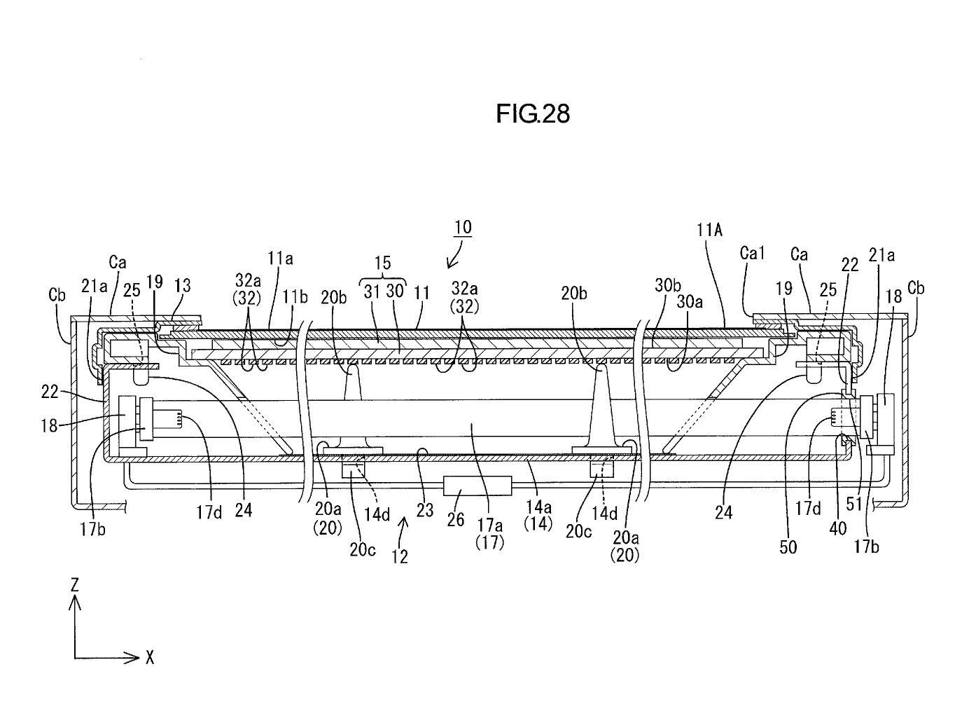

(6) In Embodiment 1 described above, although the configuration where the ferrules 17b (the power source connection sections) on both sides of the hot cathode tube 17 is exposed to the outside of the chassis 14 is used, only one of the ferrules 17b (the power source connection section at one end of the hot cathode tube 17) may be exposed to the outside of the chassis 14 as shown in FIG. 28.

(7) In Embodiment 1 described above, although a configuration using the single hot cathode tube 17 as a light source is shown, the number of the hot cathode tubes used may be changed and may be two or more. In a case of using the plurality of hot cathode tubes, the embodiment may use another configuration where, while through holes are formed at positions in the wall section of the chassis 14 that correspond to the respective hot cathode tubes, the ferrules 17b of each of the hot cathode tubes are exposed to the outside of the chassis 14.

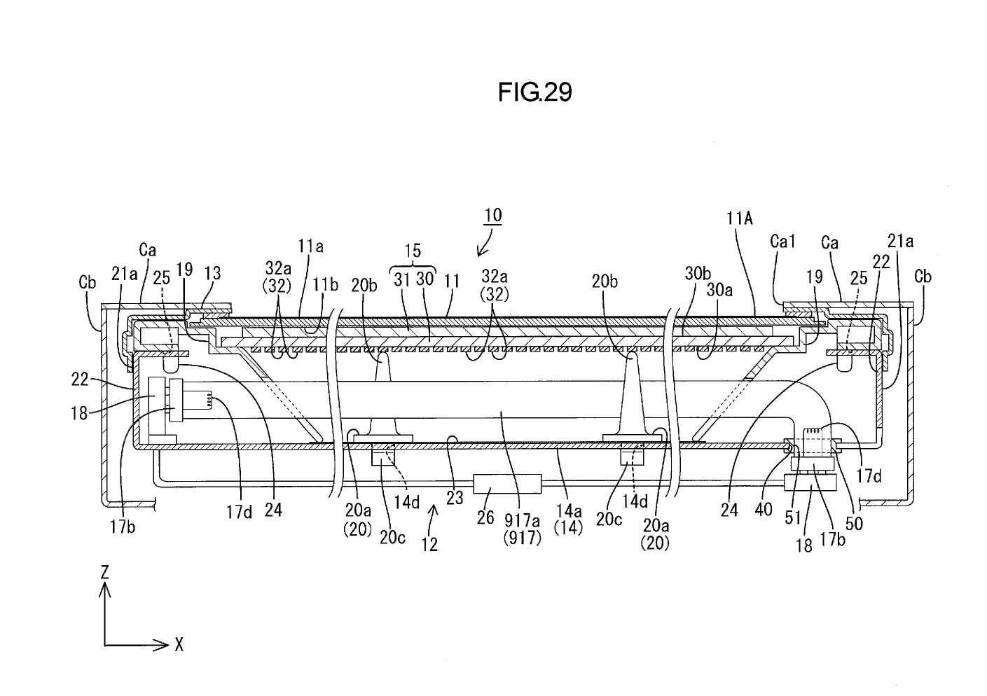

(8) Embodiment 3 described above uses the configuration where, while the discharge tube (the cold cathode tube 217) is U-shaped, the electric connection portions in both sides of the discharge tube project and are exposed from the bottom panel 214a of the chassis 214. The present invention is not limited to this, and, as shown in FIG. 29, the embodiment may use another configuration where, while a glass tube 917a of a discharge tube (a hot cathode tube 917) is made L-shaped, only the ferrule 17b at one end thereof projects from the bottom panel 14a of the chassis 14.

(9) In each of the above described embodiments, the number of the discharge tubes (each being a hot cathode tube or a cold cathode tube) may be changed as appropriate. Additionally, a direction along which hot cathode tubes are arranged in a row is not limited to the Y-axis direction, and may be changed as appropriate.

(10) Although the cooling mechanisms are configured to cool the ferrules 17b exposed to the outside of the chassis 14 in the Embodiments 16 to 20 described above, parts to be cooled are not limited to the ferrules 17b. Any cooling mechanism configured to cool a part, of the discharge tube, that is exposed to the outside of the chassis 14 is applicable as each of the cooling mechanisms. For example, in a case (each of Embodiments 10 to 15) using a configuration where a bent section of the discharge tube is exposed to the outside of the chassis 14, a cooling mechanism configured to cool the bent section is applicable.

(11) Although a configuration where the hot cathode tubes 17 are arranged in a row along the Y-axis direction is given as an example in each of the above described embodiments (6 to 9 and 12 to 15), a direction along which the hot cathode tubes are arranged in a row is not limited to the Y-axis direction, and the hot cathode tubes may be arranged in, for example, the X-axis direction. In a case where the hot cathode tubes are arranged in a row along the X-axis direction, it is only required to set the width direction of the chassis 14 to, for example, a direction (the Y-axis direction) along the short sides of the chassis 14 and configure each of the above embodiments to have the ferrules 17b of the hot cathode tubes projecting on both sides of the chassis 14 in a direction parallel to the short sides thereof.

(12) Although a case using the hot cathode tube 17 or the cold cathode tube 217 as a discharge tube is shown in each of the above described embodiments, the present invention also includes a case using a discharge tube (xenon tubes) of another type.

(13) Although one kind of light source is used in each embodiment, a case using a plurality of kinds of light source is included in the present invention. Specifically, a case where a cold cathode tube and a hot cathode tube are used in combination is also applicable.

(14) Although a case where a liquid crystal panel and a chassis are set in a stand-up state with a direction parallel to the short sides thereof agreeing with the vertical direction is given as an example in each of the above described embodiments, the present invention also includes a case where a liquid crystal panel and a chassis are set in a stand-up state with a direction parallel to the long sides thereof agreeing with the vertical direction.

(15) Although a TFT is used as each switching element of the liquid crystal display device in each of the above described embodiments, the present invention is applicable also to liquid crystal display devices using switching elements (e.g., thin-film diodes (TFDs)) other than TFTs, and to liquid crystal display devices, such as liquid crystal display devices that provide monochrome display, other than those that provide color display.

(16) Although a liquid crystal display device using a liquid crystal panel as a display panel is shown as an example in each of the above described embodiment, the present invention is applicable to the display device using other types of display panels.

(17) Although a television receiver including a tuner is given as an example in each of the above described embodiments, the present invention is applicable also to a display device not including a tuner.

1. A lighting device comprising:
a discharge tube; and
a chassis housing the discharge tube, wherein the discharge tube includes an exposed portion that is exposed to outside of the chassis.

2. The lighting device according to claim 1, further comprising a power source configured to supply driving power to the discharge tube, wherein:
the discharge tube includes a tube section, and a power source connection section that is electrically connected to the power source; and
the exposed portion is the power source connection section.

3. The lighting device according to claim 2, wherein:
the power source connection section includes a plurality of power source connection sections that are provided on two ends of the tube section, respectively; and
at least one of the power source connection sections on the two ends of the tube section is exposed to the outside of the chassis.

4. The lighting device according to claim 1, wherein:
the discharge tube includes a tube section;
the tube section includes a bent section formed by bending the tube section; and
the exposed portion is the bent section.

5. The lighting device according to claim 1, further comprising:
a power source configured to supply driving power to the discharge tube; and
a power source connection section configured to be electrically connected to the power source, wherein:
the discharge tube is formed by joining together a plurality of tube sections;
the power source connection section is provided on one end of one of the tube sections; and
the exposed portion is another end of the one tube section to which the power source connection section is provided.

6. The lighting device according to claim 1, wherein:
the discharge tube includes a plurality of discharge tubes and the plurality of the discharge tubes is arranged to be parallel to each other in the chassis, and the discharge tubes include a first discharge tube and a second discharge tube;
the first discharge tube has the exposed portion exposed to the outside of the chassis and projecting from one end of the chassis in a width direction of the chassis;
the second discharge tube has the exposed portion exposed to the outside of the chassis and projecting from another end of the chassis in the width direction of the chassis; and
the first discharge tube and the second discharge tube are alternately arranged.

7. The lighting device according to claim 1, wherein:
the discharge tube includes a plurality of discharge tubes and the plurality of discharge tubes is arranged to be parallel to each other in the chassis;
the discharge tubes include a plurality of discharge tube groups each including at least two adjacent discharge tubes;
the discharge tube groups include a first discharge tube group and a second discharge tube group;
the exposed portion of each discharge tube of the first discharge tube group is exposed to the outside of the chassis and projects toward one end of the chassis in a width direction of the chassis;
the exposed portion of each discharge tube of the second discharge tube group is exposed to the outside of the chassis and projects toward another end of the chassis in the width direction of the chassis; and
the first discharge tube group and the second discharge tube group are alternately arranged to be parallel to each other.

8. The lighting device according to claim 1, wherein:
the discharge tube includes a plurality of discharge tubes that is arranged to be parallel to each other in the chassis; and
the exposed portion of each of the discharge tubes is exposed to the outside of the chassis so as to project from one end of the chassis in a width direction of the chassis.

9. The lighting device according to claim 1, wherein:
the discharge tube includes a plurality of discharge tubes that is arranged to be parallel to each other in the chassis; and
only the discharge tubes arranged in a middle portion of the chassis in an arrangement direction of the discharge tubes have the exposed portions that are exposed to the outside of the chassis.

10. The lighting device according to claim 3, wherein the power source connection sections provided on the two ends of the tube section are exposed to the outside of the chassis.

11. The lighting device according to claim 1, wherein the discharge tube is substantially L-shaped.

12. The lighting device according to claim 1, wherein the discharge tube is substantially U-shaped.

13. The lighting device according to claim 1, wherein the discharge tube has a meandering shape.

14. The lighting device according to claim 1, wherein:
the chassis has a through hole penetrating a wall section thereof; and
the through hole is provided as a discharge tube attachment section configured to receive the discharge tube therethrough.

15. The lighting device according to claim 14, wherein:
the through hole is formed in a sidewall section of the wall section of the chassis.

16. The lighting device according to claim 14, wherein:
the chassis has a substantially box-like shape that is open toward a light output side of the lighting device; and
the through hole is formed by cutting out an edge of the wall section of the chassis.

17. The lighting device according to claim 1, wherein:
the chassis has a through hole penetrating a bottom wall section thereof; and
the through hole is provided as a discharge tube attachment section configured to receive the discharge tube therethrough.

18. The lighting device according to claim 14, further comprising an elastic member provided between an edge of the through hole and the discharge tube.

19. The lighting device according to claim 18, wherein the elastic member has a fitting groove configured to fit to the edge of the through hole.

20. The lighting device according to claim 1, wherein the discharge tube is a hot cathode tube.

21. The lighting device according to claim 1, wherein the discharge tube is a cold cathode tube.

22. A display device comprising:
the lighting device according to claim 1; and
a display panel configured to provide display by using light from the lighting device.

23. The display device according to claim 22, wherein the display panel is a liquid crystal panel using liquid crystal.

24. The display device according to claim 22, further comprising a housing member configured to house the display panel and the lighting device, wherein:
the housing member includes an opening through which a display surface of the display panel is exposed, and a frame-like section surrounding the opening; and
the exposed portion of the discharge tube is arranged within the housing member.

25. The display device according to claim 24, further comprising a cooling mechanism provided in the housing member and configured to cool the exposed portion of the discharge tube.

26. The display device according to claim 25, wherein the cooling mechanism includes a ventilation opening penetrating through the housing member.

27. The display device according to claim 25, wherein the cooling mechanism includes a cooling fan configured to send air toward the exposed portion of the discharge tube and thereby cool the exposed portion of the discharge tube.

28. The display device according to claim 25, wherein the cooling mechanism includes a cooling element configured to come in contact with the exposed portion of the discharge tube and thereby cool the exposed portion of the discharge tube.

29. The display device according to claim 25, wherein the cooling mechanism includes a heat pipe configured to transfer heat of the exposed portion of the discharge tube to the housing member.

30. The display device according to claim 25, wherein the cooling mechanism includes:
a refrigerant configured to cool the exposed portion of the discharge tube;
a circulation pipe in which the refrigerant is contained; and
a refrigerant circulation pump connected to the circulation pipe, and configured to circulate the refrigerant within the circulation pipe.

31. The display device according to claim 30, wherein the refrigerant is water.

32. A television receiver comprising the display device according to claim 22.
